(19) United States
(12) Patent Application Publication
(10) Pub. No.: US 2025/0238249 A1
(43) Pub. Date: Jul. 24, 2025

(54) ELECTRONIC DEVICE FOR SHARING SCREEN AND CONTEXT AT TIME OF SCREEN CAPTURE, OPERATION METHOD, AND STORAGE MEDIUM

(71) Applicant: Samsung Electronics Co., Ltd., Suwon-si (KR)

(72) Inventors: Jongpil YI, Suwon-si (KR); Yongam SON, Suwon-si (KR); Sejin JEON, Suwon-si (KR); Dongwon HAN, Suwon-si (KR)

(21) Appl. No.: 19/176,906

(22) Filed: Apr. 11, 2025

Related U.S. Application Data
(63) Continuation of application No. PCT/KR2023/019127, filed on Nov. 24, 2023.

(30) Foreign Application Priority Data
Dec. 5, 2022 (KR) 10-2022-0167822
Dec. 12, 2022 (KR) 10-2022-0172672

(51) Int. Cl. G06F 9/451

(52) U.S. Cl. CPC G06F 9/451

(57) ABSTRACT

An electronic device is provided. The electronic device includes a display, memory storing one or more computer programs, and one or more processors communicatively coupled to the display and the memory, wherein the one or more computer programs include computer-executable instructions that, when executed by the one or more processors individually or collectively, cause the electronic device to receive a first user input for capturing a screen being displayed on the display, in response to the receiving of the first user input, acquire an image obtained by capturing the screen, based on the acquiring of the image, acquire identification information of at least one application running on the electronic device at the time the image is acquired, location information indicating a location where an execution screen of the at least one application is displayed, and contextual information regarding the execution context of the at least one application, and store the image, the identification information, the location information, and the contextual information together.

### CROSS-REFERENCE TO RELATED APPLICATION(S)

This application is a continuation application, claiming priority under 35 U.S.C. § 365 (c), of an International application No. PCT/KR2023/019127, filed on Nov. 24, 2023, which is based on and claims the benefit of a Korean patent application number 10-2022-0167822, filed on Dec. 5, 2022, in the Korean Intellectual Property Office, and of a Korean patent application number 10-2022-0172672, filed on Dec. 12, 2022, in the Korean Intellectual Property Office, the disclosure of each of which is incorporated by reference herein in its entirety.

### BACKGROUND

### 1. Field

The disclosure relates to an electronic device, an operating method, and a storage medium for sharing a screen and a context at the time of screen capture.

### 2. Description of Related Art

An electronic device may provide a screen capture function. For example, the electronic device may store text or images included in a screen displayed on a display in the form of an image by using the screen capture function. For example, the electronic device may edit or share the captured image by using the screen capture function.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, an operating method, and a storage medium for sharing a screen and a context at the time of screen capture.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory storing one or more computer programs, and one or more processors communicatively coupled to the display and the memory, wherein the one or more computer programs include computer-executable instructions that, when executed by the one or more processors individually or collectively, cause the electronic device to receive a first user input for capturing a screen being displayed on the display, in response to the receiving of the first user input, acquire an image obtained by capturing the screen, based on the acquiring of the image, acquire identification information of at least one application running on the electronic device at a point in time when the image is acquired, location information indicating a location where an execution screen of the at least one application is displayed, and contextual information about an execution context of the at least one application, and store the image, the identification information, the location information, and the contextual information together.

In accordance with another aspect of the disclosure, a method performed by an electronic device is provided. The method includes receiving, by the electronic device, a first user input for capturing a screen being displayed on a display of the electronic device, in response to the receiving of the first user input, acquiring, by the electronic device, an image obtained by capturing the screen, based on the acquiring of the image, acquiring, by the electronic device, identification information of at least one application running on the electronic device at a point in time at which the image is acquired, location information indicating a location where an execution screen of the at least one application is displayed, and contextual information about an execution context of the at least one application, and storing, by the electronic device, the image, the identification information, the location information, and the contextual information together.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, by the electronic device, a first user input for capturing a screen being displayed on a display of the electronic device, in response to the receiving of the first user input, acquiring, by the electronic device, an image obtained by capturing the screen, based on the acquiring of the image, acquiring, by the electronic device, identification information of at least one application running on the electronic device at a point in time at which the image is acquired, location information indicating a location where an execution screen of the at least one application is displayed, and contextual information about an execution context of the at least one application, and storing, by the electronic device, the image, the identification information, the location information, and the contextual information together.

In accordance with another aspect of the disclosure, an electronic device is provided. The electronic device includes a display, a communication circuit, memory storing one or more computer programs, and one or more processors communicatively coupled to the display, the communication circuit, and the memory, wherein the one or more computer programs include computer-executable instructions that, when executed by the one or more processors individually or collectively, cause the electronic device to receive, through the communication circuit, a request for reproducing an execution state of at least one application at a time point of screen capture of an external electronic device, in response to receiving a user input for accepting the request, receive, through the communication circuit, an image obtained by capturing a screen of the external electronic device, identification information of the at least one application, location information indicating a location where an execution screen of the at least one application is displayed, and contextual information about an execution context of the at least one application, execute the at least one application corresponding to the identification information, and display the execution screen of the at least one application on the display based on the location information, and wherein an execution screen of each application corresponds to contextual information of each application.

In accordance with another aspect of the disclosure, a method performed by an electronic device is provided. The method includes receiving, by the electronic device through a communication circuit of the electronic device, a request for reproducing an execution state of at least one application at a time point of screen capture of an external electronic device, in response to receiving a user input for accepting the request, receiving, by the electronic device through the communication circuit, an image obtained by capturing a screen of the external electronic device, identification information of the at least one application, location information indicating a location where an execution screen of the at least one application is displayed, and contextual information about an execution context of the at least one application, executing, by the electronic device, the at least one application corresponding to the identification information, and displaying, by the electronic device on a display of the electronic device, the execution screen of the at least one application based on the location information, wherein an execution screen of each application corresponds to contextual information of each application.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, by the electronic device through a communication circuit of the electronic device, a request for reproducing an execution state of at least one application at a time point of screen capture of an external electronic device, in response to receiving a user input for accepting the request, receiving, by the electronic device through the communication circuit, an image obtained by capturing a screen of the external electronic device, identification information of the at least one application, location information indicating a location where an execution screen of the at least one application is displayed, and contextual information about an execution context of the at least one application, executing, by the electronic device, the at least one application corresponding to the identification information, and displaying, by the electronic device on a display of the electronic device, the execution screen of the at least one application, wherein an execution screen of each application corresponds to contextual information of each application.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram showing a configuration of a system, according to an embodiment of the disclosure;

FIG. 2 is a flowchart illustrating an operation of an electronic device, according to an embodiment of the disclosure;

FIG. 3 is a drawing showing an example of a user input for capturing a screen of an electronic device according to an embodiment of the disclosure;

FIG. 4 is a drawing showing an example of a user interface, which is provided by an electronic device and which is used to share a captured screen and a context at the time of screen capture according to an embodiment of the disclosure;

FIG. 5 is a drawing showing an example of a user interface, which is provided by an electronic device and which is used to select data to be transmitted before a capture image file is shared according to an embodiment of the disclosure;

FIG. 6 is a drawing showing an example in which an electronic device manages a list of capture image files through a cloud server according to an embodiment of the disclosure;

FIG. 7 is a drawing showing an example in which an electronic device shares a capture image file to an external electronic device according to an embodiment of the disclosure;

FIG. 8 is a drawing showing an example in which an electronic device shares a capture image file to an external electronic device according to an embodiment of the disclosure;

FIG. 9 is a drawing showing an example in which an electronic device shares a capture image file to an external electronic device according to an embodiment of the disclosure;

FIG. 10 is a drawing showing an example in which an electronic device shares a capture image file to an external electronic device according to an embodiment of the disclosure;

FIG. 11 is a flowchart illustrating an operation of an electronic device, according to an example according to an embodiment of the disclosure;

FIG. 12 is a flowchart illustrating an operation of an electronic device, according to an example according to an embodiment of the disclosure; and

FIG. 13 is a block diagram of an electronic device in a network environment, according to an example according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

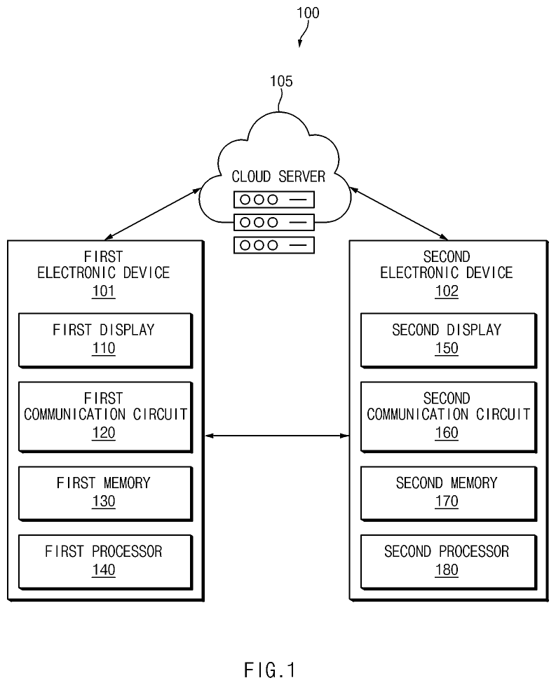

FIG. 1 is a block diagram showing a configuration of a system, according to an embodiment of the disclosure.

Referring to FIG. 1, block diagram 100 shows a system including, according to an example, a first electronic device 101, a second electronic device 102, and/or a cloud server 105.

The first electronic device 101 may include a first display 110, a first communication circuit 120, first memory 130, and/or a first processor 140. For example, the first electronic device 101 may further include other components not illustrated in FIG. 1.

The first display 110 may visually provide information to a user. For example, the first display 110 may show an execution screen of an application. For example, the first display 110 may display a graphical user interface (GUI) provided by the first electronic device 101. For example, the GUI may include a user interface for capturing and sharing the execution context of at least one application running on the first electronic device 101 together with a screen displayed on the first display 110.

The first communication circuit 120 may support communication between the first electronic device 101 and an external electronic device (e.g., the second electronic device 102 or the cloud server 105). The first communication circuit 120 may communicate with the external electronic device over a network. For example, the network may include a short-range communication network such as Bluetooth™ or Wi-Fi™ Direct, or a long-range communication network such as a legacy cellular network, a fifth generation (5G) network, or the Internet. The first communication circuit 120 may exchange data or files with the external electronic device over the network.

For example, when the second electronic device 102 is within a range permitted in Bluetooth™ or Wi-Fi™ Direct from the first electronic device 101, the first communication circuit 120 may communicate with the second electronic device 102 through Bluetooth™ or Wi-Fi™ Direct. For example, when the second electronic device 102 is out of range from the first electronic device 101 through Bluetooth™ or Wi-Fi™ Direct, the first communication circuit 120 may communicate with the second electronic device 102 over the long-range communication network, such as a legacy cellular network, a 5G network, or the Internet.

For example, the first electronic device 101 may not communicate directly with the second electronic device 102, but may exchange data through the cloud server 105. The first electronic device 101 and the second electronic device 102 may be registered as a plurality of devices of the same user account in the cloud server 105. For example, the second electronic device 102 may download data, which is uploaded by the first electronic device 101 onto the cloud server 105, by accessing the cloud server 105 with the same user account as a user account of the first electronic device 101.

The first memory 130 may store one or more instructions for operating the first electronic device 101. The first memory 130 may store data or information necessary for the operation of the first electronic device 101. For example, the first memory 130 may store an image obtained by capturing a screen displayed on the first display 110. For example, the first memory 130 may store information for reproducing the execution state of at least one application running on the first electronic device 101 at the time of screen capture, together with an image captured from the screen. For example, information for reproducing the execution state of at least one application may include identification information of at least one application, location information indicating a location where the execution screen of the at least one application is displayed, and/or contextual information about the execution context of the at least one application.

The first processor 140 may be operatively connected to the first display 110, the first communication circuit 120, and the first memory 130. The meaning of being operatively connected between components may mean that components are functionally connected or communicatively connected to each other. For example, components thus operatively connected may exchange data with each other. The first processor 140 may execute one or more instructions stored in the first memory 130.

The first processor 140 may receive a user input for capturing the screen displayed on the first display 110. For example, a user input for capturing the screen may be an input for simultaneously pressing two buttons formed side by side on the side housing of the first electronic device 101. For example, one of the two buttons may be a volume control button, and the other may be a button configured to execute a specified function of an electronic device depending on an input type. For example, the user input for capturing the screen may be a gesture input for swiping the first display 110 with a hand from one side to the opposite side. For example, the gesture input may include swiping from left to right or from right to left. However, this is only an example, and various embodiments are not limited thereto.

The first processor 140 may obtain an image, which is obtained by capturing a screen displayed on the first display 110, in response to receiving the user input for capturing the screen. For example, an image obtained by capturing the screen may be a still image.

The first processor 140 may obtain identification information of at least one application running on the first electronic device 101 at a point in time when an image obtained by capturing the screen is obtained, location information indicating a location where an execution screen of the at least one application is displayed, and/or contextual information about an execution context of the at least one application.

The first processor 140 may obtain identification information of the at least one application running on the first electronic device 101 at the point in time when an image obtained by capturing the screen is obtained. The identification information may be information for identifying an application and may include, for example, a name, an identifier (ID), and/or a classification code. For example, when the captured screen is a multi-window screen including execution screens of a plurality of applications, the first processor 140 may obtain the identification information of each of the plurality of applications.

The first processor 140 may obtain the location information indicating the location where the execution screen of at least one application is displayed. For example, the location information may include a ratio of each execution screen and/or the layout of at least one execution screen. In the disclosure, the ratio of each execution screen may be referenced as an aspect ratio of each execution screen. In the disclosure, the layout may indicate a location and a size where at least one execution screen is arranged on a display area of the first display 110. For example, when the captured screen is a multi-window screen including execution screens of a plurality of applications, the first processor 140 may obtain a layout indicating a screen dividing method for the multi-window screen.

The first processor 140 may obtain the contextual information about the execution context of at least one application. For example, when the captured screen is a multi-window screen including execution screens of a plurality of applications, the first processor 140 may obtain the contextual information of each of the plurality of applications.

For example, when the application is displaying a website or a webpage, the first processor 140 may obtain address information (e.g., uniform resource locator (URL)) of the website or a webpage and/or location information of the webpage as the contextual information. For example, the location information of a web page may include page information or scroll information. For example, when the application is playing a web video, the first processor 140 may obtain the address information (e.g., URL) and/or playback time information of the web video as the contextual information.

For example, when the application is an image viewer application or a media player application, the first processor 140 may obtain an original image or original media content (e.g., music or videos) as the contextual information. For example, when the application is a contact application, the first processor 140 may obtain contact information as the contextual information. For example, when the application is a message application, the first processor 140 may obtain message content information as the contextual information. For example, when the application is a document creation application or a document editing application, the first processor 140 may obtain a document file being created or edited and current location information of a document as the contextual information. For example, the current location information of the document may include information about a current page of the document.

As described above, the first processor 140 may be configured to collect the corresponding contextual information for each application or information included in the execution screen of an application. For example, when there is contextual information set to be collected with respect to the running application, the first processor 140 may obtain the contextual information. For example, when there is no contextual information set to be collected with respect to the running application, the first processor 140 may not obtain the contextual information, but may obtain only identification information of the application and/or location information of the application.

For example, when there is an external electronic device (e.g., an earphone, an earbud, a speaker, or a microphone) connected to the first electronic device 101 through the first communication circuit 120 at a point in time when the image obtained by capturing a screen is obtained, the first processor 140 may obtain the connected device information as the contextual information.

For example, there may be an application, whose execution screen is not displayed on the first display 110, from among applications running at the point in time when the image obtained by capturing the screen is obtained. For example, when the first electronic device 101 supports a two-split multi-window screen and three applications are running, the first electronic device 101 may display only an icon minimally indicating that the corresponding application is running without displaying the execution screen of one of the three applications. In this case, the first processor 140 may obtain only the identification information and/or the contextual information of the corresponding application, without obtaining the location information for the corresponding application.

The first processor 140 may store the image obtained by capturing the screen (or, the captured image), the identification information, the location information, and/or the contextual information together. For example, the first processor 140 may store the identification information, the location information, and/or the contextual information as metadata of the image. For example, the first processor 140 may add the identification information, the location information, and/or the contextual information as the metadata to the captured image and may store them in an exchangeable image file format (EXIF). Hereinafter, a file including the capture image, and the identification information, the location information, and/or the contextual information, which is the metadata of the capture image, may be referenced as a “capture image file”.

The first processor 140 may store the capture image file in the first memory 130. For example, the first processor 140 may transmit the capture image file to the cloud server 105 through the first communication circuit 120 so as to be stored. For example, the first processor 140 may list and store the capture image file in the first memory 130 or the cloud server 105 at each capture time point. For example, the cloud server 105 may manage a list of capture image files and may provide a service for uploading or downloading the capture image files.

The first processor 140 may establish a communication connection with an external electronic device (e.g., the second electronic device 102) in proximity to the first electronic device 101 through the first communication circuit 120. In the disclosure, the proximity may be referenced as being located within a specified range (e.g., a distance or a radius). For example, the first electronic device 101 and the second electronic device 102 may communicate with each other through Bluetooth™ or Wi-Fi™ Direct. The first processor 140 may transmit a capture image file to the second electronic device 102 through the first communication circuit 120.

The first processor 140 may receive a user input for sharing the capture image file with the second electronic device 102. For example, the first processor 140 may display a data list to be transmitted on the first display 110 in response to receiving a user input for sharing the capture image file with the second electronic device 102. The data list to be transmitted may be referenced as a metadata list of the capture image to be transmitted. The metadata list may include a list of identification information, location information, and/or contextual information.

For example, the first processor 140 may receive a user input for selecting data, which does not need to be transmitted, from the data list to be transmitted. For example, the first processor 140 may transmit data other than data selected by the corresponding user input to the second electronic device 102 in response to a user input for selecting data, which does not need to be transmitted.

For example, the first processor 140 may transmit a notification to the second electronic device 102 in response to receiving the user input for sharing the capture image file with the second electronic device 102. For example, the first processor 140 may transmit a capture image file to the second electronic device 102 in response to receiving, from the second electronic device 102, a notification indicating that the sharing has been accepted.

For example, the first processor 140 may transmit a message including a capture image file to the second electronic device 102 through a message sending application.

For example, the first electronic device 101 and the second electronic device 102 may be registered in the cloud server 105 with the same user account. For example, in response to the first electronic device 101 uploading the capture image file to the cloud server 105, the cloud server 105 may transmit a notification to the second electronic device 102, which is another electronic device registered with the same user account as the first electronic device 101. For example, the second electronic device 102 may receive a user input for accepting the sharing of the capture image file in response to the notification received from the cloud server 105. The second electronic device 102 may receive the capture image file from the cloud server 105 in response to receiving the user input for accepting the sharing of the capture image file.

For example, when there is an external electronic device (e.g., an earphone, an earbud, a speaker, or a microphone) connected to the first electronic device 101 through the first communication circuit 120 at the point in time when a capture image is obtained, the first processor 140 may connect the external electronic device to the second electronic device 102 in response to a user input for sharing (or transmitting) the capture image file with the second electronic device 102 or receiving, from the second electronic device 102, a notification that the sharing of the capture image file has been accepted. For example, the external electronic device may be connected to the first electronic device 101 and the second electronic device 102 through Bluetooth™. For example, the external electronic device may be connected to the first electronic device 101 at the point in time when a capture image is obtained, and may be connected to the second electronic device 102 after the capture image file is shared. For example, as sharing the capture image file with the second electronic device 102, the first processor 140 may disconnect the first electronic device 101 from the external electronic device, and may connect the external electronic device to the second electronic device 102.

For example, when the first electronic device 101 and the second electronic device 102 are registered in the cloud server (e.g., the cloud server 105) with the same user account, the first electronic device 101 and the second electronic device 102 may share device information (e.g., device information of the external electronic device) connected to each electronic device with each other. Accordingly, the second electronic device 102 may be connected to the external electronic device without performing a pairing process with the external electronic device.

The second electronic device 102 may include a second display 150, a second communication circuit 160, second memory 170, and/or a second processor 180. For example, the second electronic device 102 may further include other components not illustrated in FIG. 1.

The second display 150 may visually provide information to a user. For example, the second display 150 may show an execution screen of an application. For example, the second display 150 may display a GUI provided by the second electronic device 102. For example, the GUI may include a user interface for accepting or rejecting sharing (or transfer) of a capture image file from an external electronic device (e.g., the first electronic device 101 or the cloud server 105).

The second communication circuit 160 may support communication between the second electronic device 102 and an external electronic device (e.g., the first electronic device 101 or the cloud server 105). The second communication circuit 160 may communicate with the external electronic device over a network. For example, the network may include a short-range communication network such as Bluetooth™ or Wi-Fi™ Direct, or a long-range communication network such as a legacy cellular network, a 5G network, or the Internet. The second communication circuit 160 may exchange data or files with the external electronic device over the network.

For example, when the second electronic device 102 is within a range permitted in Bluetooth™ or Wi-Fi™ Direct from the first electronic device 101, the second communication circuit 160 may communicate with the first electronic device 101 through Bluetooth™ or Wi-Fi™ Direct. For example, when the second electronic device 102 is out of range from the first electronic device 101 through Bluetooth™ or Wi-Fi™ Direct, the second communication circuit 160 may communicate with the first electronic device 101 over the long-range communication network, such as a legacy cellular network, a 5G network, or the Internet.

For example, the second electronic device 102 may not communicate directly with the first electronic device 101, but may exchange data through the cloud server 105. The first electronic device 101 and the second electronic device 102 may be registered as a plurality of devices of the same user account in the cloud server 105. For example, the second electronic device 102 may download data, which is uploaded by the first electronic device 101 onto the cloud server 105, by accessing the cloud server 105 with the same user account as a user account of the first electronic device 101.

The second memory 170 may store one or more instructions for operating the second electronic device 102. The second memory 170 may store data or information necessary for the operation of the second electronic device 102. For example, the second memory 170 may store a capture image file received from the first electronic device 101.

The second processor 180 may be operatively connected to the second display 150, the second communication circuit 160, and the second memory 170. The meaning of being operatively connected between components may mean that components are functionally connected or communicatively connected to each other. For example, components thus operatively connected may exchange data with each other. The second processor 180 may execute one or more instructions stored in the second memory 170.

The second processor 180 may receive, through the second communication circuit 160, a request for reproducing the execution state of at least one application at a point in time, when a screen of an external electronic device (e.g., the first electronic device 101) is captured. For example, the request may be a request for the sharing of a capture image file. The second processor 180 may receive the request for the sharing of the capture image file from the first electronic device 101 or the cloud server 105. For example, the request for the sharing of the capture image file may be included in a notification transmitted to the second electronic device 102 by the first electronic device 101 in response to receiving a user input for sharing the capture image file. For example, the request for the sharing of the capture image file may be included in a notification transmitted by the cloud server 105 to the second electronic device 102, which is registered with the same user account as the first electronic device 101, in response to receiving the capture image file from the first electronic device 101.

The second processor 180 may receive a capture image file through the second communication circuit 160 in response to receiving a user input for accepting the request. For example, the second processor 180 may display, on the second display 150, a GUI for accepting or rejecting a request in response to receiving the request to share a capture image file. The second processor 180 may receive a capture image file from the first electronic device 101 or the cloud server 105 in response to receiving a user input for accepting the request for the sharing of the capture image file.

For example, the capture image file may include an image (or a capture image) obtained by capturing the screen of the first electronic device 101, identification information of at least one application running at the time of screen capture of the first electronic device 101, location information indicating a location where an execution screen of the at least one application is displayed, and/or contextual information about an execution context of the at least one application. For example, the identification information, the location information, and/or the contextual information may be metadata of a capture image.

The second processor 180 may execute at least one application corresponding to the identification information. For example, the second processor 180 may launch the at least one application as an application of a version supported by the second electronic device 102.

For example, when at least one application corresponding to the identification information is not installed (or stored) in the second electronic device 102, the second processor 180 may provide an installation link for the corresponding application.

For example, when at least one application corresponding to the identification information is not installed (or stored) in the second electronic device 102 and the first electronic device 101 is located within a specified range (e.g., a mirrorable distance or radius) of the second electronic device 102, the second processor 180 may mirror (or miracast™) the execution screen of the corresponding application displayed on the first display 110 of the first electronic device 101 so as to be displayed on the second display 150.

The second processor 180 may display the execution screen of at least one application on the second display 150 based on the location information. For example, the second processor 180 may display the execution screen of the at least one application on the second display 150 such that a ratio of the execution screen of each application corresponds to (e.g., matches) a ratio of an execution screen displayed on the first display 110 of the first electronic device 101.

For example, the second processor 180 may display the execution screen of the at least one application on the second display 150 such that the execution screen of each application corresponds to the location and size (e.g., a ratio of an area, on which the execution screen of the corresponding application is displayed, to the area of the entire display area) of the display area of the first display 110 of the first electronic device 101. For example, the first display 110 and the second display 150 may have different sizes (e.g., width and/or height) and aspect ratios from each other. For example, the second processor 180 may adjust the location and size of the execution screen of each application based on a difference in size and/or aspect ratio between the first display 110 and the second display 150, and then may display the execution screen of at least one application on the second display 150.

For example, a screen captured from the first electronic device 101 may include execution screens of a plurality of applications, and the second electronic device 102 may display the execution screens of the plurality of applications on one screen. For example, the second electronic device 102 may support a multi-window screen (or, a multi-window function). In this case, the second processor 180 may display the execution screens of a plurality of applications on the second display 150 based on location information. For example, the location information may include the layout of the execution screens of the plurality of applications.

For example, the second processor 180 may display the execution screens of the plurality of applications on the second display 150 based on the layout of the execution screens of the plurality of applications received from the first electronic device 101. For example, the second processor 180 may display the execution screens of the plurality of applications on the second display 150 such that the layout of the execution screens of the plurality of applications corresponds to the layout displayed on the first display 110 of the first electronic device 101.

For example, the captured screen including the execution screens of the plurality of applications may be referenced as a multi-window screen. For example, the second processor 180 may split the display area of the second display 150 so as to correspond to the screen dividing method of the multi-window screen displayed on the first display 110, and may display the execution screens of the plurality of applications in the split areas of the second display 150, respectively.

For example, both the first electronic device 101 and the second electronic device 102 may support a multi-window screen. The number of split screens supported by the second electronic device 102 may be greater than the number of split screens supported by the first electronic device 101. For example, when the number of applications running on the first electronic device 101 is greater than the number of split screens supported by the first electronic device 101 at the time of screen capture, the first electronic device 101 may display only some execution screens of the plurality of applications, which is running on the first display 110, on the first display 110. For example, the first electronic device 101 may display an icon indicating an application with respect to the remaining running applications that do not have an execution screen displayed on the first display 110. Accordingly, the captured screen may include the execution screens of a portion of the running applications. However, the first electronic device 101 may also obtain identification information and/or contextual information of an application with respect to the running application even when it is not displayed on the first display 110, and may transmit a capture image file including the corresponding information to the second electronic device 102. When the number of split screens supported by the second electronic device 102 is greater than or equal to the number of applications running on the first electronic device 101 at the time of screen capture, the second electronic device 102 may create a multi-window screen including an execution screen of an application, which is not displayed on the first display 110, and may display the multi-window screen on the second display 150.

The execution screen of each application may correspond to contextual information of each application. The second processor 180 may display the execution screen of at least one application on the second display 150 so as to correspond to the contextual information of each application.

For example, when the contextual information of an application includes a URL and page information of a web page, the second processor 180 may display a page corresponding to the page information of the web page corresponding to the URL on the execution screen of the corresponding application. For example, when the contextual information of an application includes a URL and scroll information of a web page, the second processor 180 may display a page scrolled down by the amount corresponding to the scroll information of the web page corresponding to the URL on the execution screen of the corresponding application.

For example, when the contextual information of the application includes a URL and playback time point information, the second processor 180 may play a web video corresponding to the URL on the execution screen of the corresponding application, starting from a time point corresponding to the playback time point information on the page.

For example, when the contextual information of an application includes an original image, the second processor 180 may display the corresponding image on the execution screen of the corresponding application. For example, when the contextual information of the application includes original music or an original video, the second processor 180 may play the corresponding music or video on the execution screen of the corresponding application. For example, when music or videos have been playing through an external electronic device connected to the first electronic device 101 at the time of screen capture, the second processor 180 may play the music or videos through the external electronic device after receiving a capture image file. For example, the contextual information of an application may include playback time point information together with the original music or the original video. The second processor 180 may play the corresponding music or video on the execution screen of the corresponding application from the playback time point corresponding to the playback time point information.

For example, when the contextual information of an application includes contact information, the second processor 180 may display the corresponding contact information on the execution screen of the corresponding application. For example, when the contextual information of an application includes message content information, the second processor 180 may display the corresponding message content information on the execution screen of the corresponding application.

For example, when the contextual information of an application includes a document file being created or edited and current page information of a document, the second processor 180 may display the page corresponding to the current page information of the document corresponding to the document file on the execution screen of the corresponding application.

For example, when the screen captured from the first electronic device 101 includes execution screens of a plurality of applications, the second processor 180 may display the execution screens of the plurality of applications on the second display 150 so as to correspond to contextual information of each application.

For example, the captured screen may include execution screens of a plurality of applications, but the second electronic device 102 may fail to display the execution screens of the plurality of applications on one screen. For example, the second electronic device 102 may not support a multi-window screen (or, a multi-window function). In this case, the second processor 180 may display the execution screen of one of the plurality of applications (e.g., the execution screen of the first application) on the second display 150. For example, while the execution screen of the first application is displayed on the second display 150, the second processor 180 may receive a user input for identifying the list of recently executed applications. For example, in response to a user input for identifying the list of recently executed applications, the second processor 180 may provide a list of a plurality of applications, including an execution screen (e.g., the execution screen of the first application) displayed on the second display 150 and the other execution screens (e.g., the execution screens of the other applications other than the first application) not displayed on the second display 150. For example, in response to receiving a user input for selecting an application other than the first application from a list of applications, the second processor 180 may display the execution screen of the selected application on the second display 150.

In the above-described embodiment, it is described that the first electronic device 101 is a device that captures and shares (or transmits) a screen and a context at the time of screen capture, and the second electronic device 102 is a device that shares the captured screen and the context at the time of screen capture, but is not limited thereto. For example, the second electronic device 102 may also capture the screen and the context at the time of screen capture, and may share (or transmit) the captured result to the first electronic device 101.

According to the above-described embodiment, the first electronic device 101 and the second electronic device 102 may share a screen captured from one electronic device to another electronic device, together with the context at the time of screen capture. An electronic device, with which the captured screen and the context are shared, may reproduce (or subsequently provide) the screen and the context at the time of screen capture of the electronic device that shares the captured screen and the context.

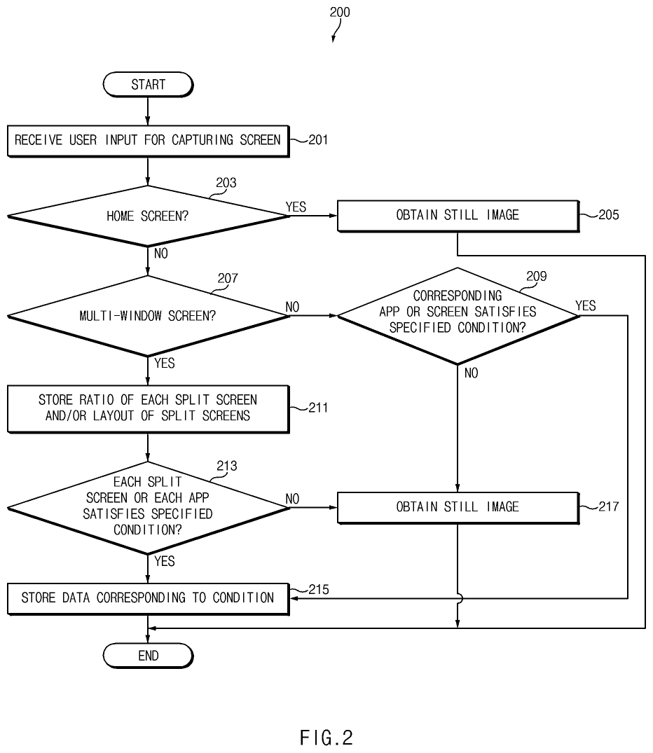

FIG. 2 is a flowchart illustrating an operation of an electronic device, according to an embodiment of the disclosure. For example, operations of an electronic device to be described later may be performed by the first electronic device 101 of FIG. 1 or the first processor 140 of the first electronic device 101.

Referring to FIG. 2, flowchart 200 illustrates that, in operation 201, an electronic device may receive a user input for capturing a screen. For example, the user input for capturing the screen may be an input for simultaneously pressing two buttons formed side by side on the side housing of the electronic device. For example, one of the two buttons may be a volume control button, and the other may be a button configured to execute a specified function of an electronic device depending on an input type. For example, the user input for capturing the screen may be a gesture input for swiping a display (e.g., the first display 110) with a hand from one side to the opposite side. For example, the gesture input may include swiping from left to right or from right to left.

In operation 203, the electronic device may determine whether a screen displayed on a display is a home screen. The home screen may be a first screen or a start screen of the electronic device, and may include, for example, frequently used application icons, application folders, or widgets. When the screen displayed on the display is the home screen, the electronic device may perform operation 205. When the screen displayed on the display is not the home screen, the electronic device may perform operation 207.

In operation 205, the electronic device may obtain a still image obtained by capturing the screen. The electronic device may obtain the still image obtained by capturing the home screen.

In operation 207, the electronic device may determine whether the screen displayed on the display is a multi-window screen. The multi-window screen may be a screen in which an electronic device splits the entire display area of the display and respectively displays execution screens of the plurality of applications on the split areas. The electronic device displaying the multi-window screen may be referenced as the electronic device running a plurality of applications and simultaneously displaying execution screens of the plurality of applications. When the screen displayed on the display is not the multi-window screen, the electronic device may perform operation 209. When the screen displayed on the display is the multi-window screen, the electronic device may perform operation 211.

When the screen displayed on the display is not the multi-window screen, the electronic device may be displaying the execution screen of one application on the display. In operation 209, the electronic device may determine whether a running application or an execution screen of the application satisfies a specified condition. For example, the specified condition may include a condition regarding an application configured to collect contextual information or the execution screen of the application. When the running application or the execution screen of the application satisfies the specified condition, the electronic device may perform operation 215. When the running application or the execution screen of the application does not satisfy the specified condition, the electronic device may perform operation 217.

In operation 215, the electronic device may store data corresponding to the condition. When the running application or the execution screen of the application satisfies the specified condition, the electronic device may store data corresponding to the condition. The electronic device may store data corresponding to the condition. For example, when the running application or the execution screen of the application is an application configured to collect contextual information or the execution screen of the application, the electronic device may obtain and store contextual information corresponding to the application or the execution screen of the application.

For example, the specified condition may include whether the application is an application that displays a website or a webpage, or whether the execution screen of the application is displaying a website or a webpage. When the running application is an application that displays a website or a webpage, or the execution screen of the application is displaying a website or a webpage, the electronic device may determine that the specified condition is satisfied. For example, when the running application is an application that displays a website or a webpage, or the execution screen of the application is displaying a website or a webpage, the electronic device may store address information (e.g., URL) of the website or a webpage and/or location information of the webpage as contextual information. For example, the location information of a web page may include page information or scroll information.

For example, the specified condition may include whether the application is an application that plays a web video, or whether the execution screen of the application is a web video playback screen. When the running application is an application that plays a web video, or the execution screen of the application is a playback screen of the web video, the electronic device may determine that the specified condition is satisfied. For example, when the running application is an application that plays a web video, or the execution screen of the application is a playback screen of a web video, the electronic device may store address information (e.g., URL) and/or playback time point information of the web video as contextual information.

For example, the specified condition may include whether the application is an image viewer application or a media player application, or whether the execution screen of the application is a screen that displays an image or a screen that plays media content. When the running application is an image viewer application or a media player application, or the execution screen of the application is a screen that displays an image or a screen that plays media content, the electronic device may determine that the specified condition is satisfied. For example, when the running application is an image viewer application or a media player application, or the execution screen of the application is a screen that displays an image or a screen that plays media content, the electronic device may store an original image or original media content (e.g., music or videos) as contextual information.

For example, the specified condition may include whether the application is a contact application, or whether the execution screen of the application includes contact information. When the running application is a contact application, or the execution screen of the application is a screen including contact information, the electronic device may determine that the specified condition is satisfied. For example, when the running application is a contact application, or the execution screen of the application is a screen including contact information, the electronic device may store the contact information as contextual information.

For example, the specified condition may include whether the application is a message application, or whether the execution screen of the application includes message content information. When the running application is a message application, or the execution screen of the application is a screen including message content information, the electronic device may determine that the specified condition is satisfied. For example, when the running application is a message application, or the execution screen of the application is a screen including message content information, the electronic device may store the message content information as contextual information.

For example, the specified condition may include whether the application is a document creation application or a document editing application, or whether the execution screen of the application is the document screen being created or edited. When the running application is a document creation application or a document editing application, or the execution screen of the application is a document screen that is being created or edited, the electronic device may determine that the specified condition is satisfied. For example, when the running application is a document creation application or a document editing application, or the execution screen of the application is a document screen that is being created or edited, the electronic device may store a document file being created or edited and current location information of a document as contextual information. For example, the current location information of the document may include information about a current page of the document.

In operation 217, the electronic device may obtain a still image obtained by capturing a screen. When the running application or the execution screen of the application does not satisfy the specified condition, the electronic device may obtain and store the still image, which is obtained by capturing the screen (e.g., the execution screen of the application) displayed on the display. For example, when a running application or the execution screen of the application is not an application configured to collect contextual information or the execution screen of the application, the electronic device may obtain and store a still image obtained by capturing the execution screen of the application.

When the screen displayed on the display is a multi-window screen, the electronic device may be displaying execution screens of a plurality of applications on the display. The multi-window screen may include a plurality of split screens (or windows). The plurality of split screens may correspond to the execution screens of the plurality of applications, respectively. In operation 211, the electronic device may store the ratio of each split screen and/or the layout of split screens. The ratio of each split screen may be referred to as an “aspect ratio of each split screen”. The layout of split screens may indicate a location and a size where the split screens are arranged on a display area of the display. For example, the layout of split screens may include location information indicating locations where the execution screens of the plurality of applications are displayed. The layout of split screens may indicate a screen splitting method for a multi-window screen.

In operation 213, the electronic device may determine whether each split screen or an application running on each split screen satisfies a specified condition. The specified condition in operation 213 may be the same as the specified condition in operation 209. For example, the specified condition may include a condition regarding an application configured to collect contextual information or the execution screen of the application. When an application running on each split screen or each split screen satisfies the specified condition, the electronic device may perform operation 215. When an application running on each split screen or each split screen does not satisfy the specified condition, the electronic device may perform operation 217. When the screen displayed on the display is a multi-window screen including execution screens of the plurality of applications, the electronic device may perform operations 213, 215, and 217 on a plurality of split screens or a plurality of applications running on the plurality of split screens.

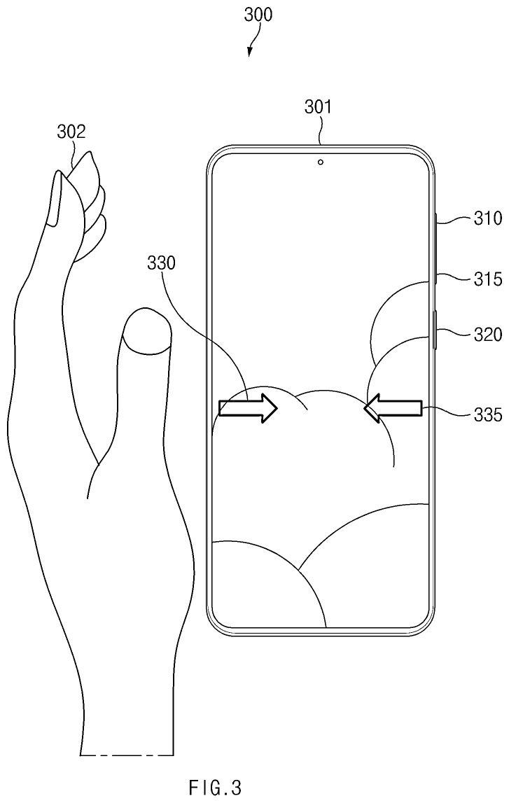

FIG. 3 is a drawing showing an example of a user input for capturing a screen of an electronic device according to an embodiment of the disclosure. An electronic device 301 described below may be the first electronic device 101 of FIG. 1.

Referring to FIG. 3, drawing 300 shows that an electronic device 301 may include two buttons formed side by side on side housing. A first button may be a volume control button, which may include an up button 310 for increasing volume and a down button 315 for decreasing the volume. A second button 320 may be a button configured to execute a specified function of an electronic device depending on an input type. For example, the second button 320 may be formed below the down button 315, but is not limited thereto, and may also be formed above the up button 310.

For example, a user input for capturing a screen of the electronic device 301 may include an input for simultaneously pressing two buttons formed side by side on the side housing of the electronic device 301. For example, the user input for capturing the screen of the electronic device 301 may include simultaneously pressing the down button 315 and the second button 320. For example, when the second button 320 is formed above the up button 310, the user input for capturing the screen of the electronic device 301 may include an input of simultaneously pressing the up button 310 and the second button 320.

For example, the user input for capturing the screen of the electronic device 301 may be a gesture input for swiping a display with a hand 302 from one side to the opposite side. For example, the gesture input may include a swiping gesture input in a first direction 330 from left to right, or a second direction 335 from right to left.

The electronic device 301 may obtain an image, which is obtained by capturing a screen, in response to receiving the user input for capturing the screen.

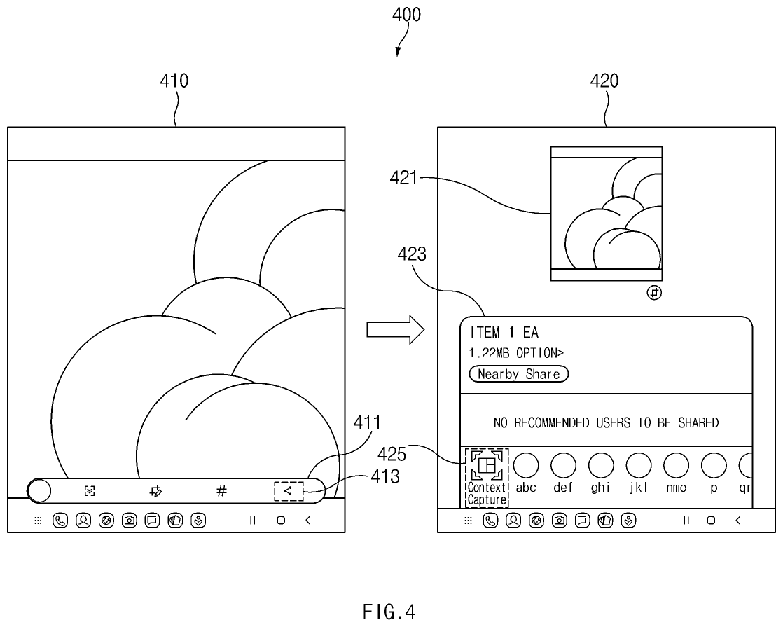

FIG. 4 is a drawing showing an example of a user interface, which is provided by an electronic device and which is used to share a captured screen and a context at the time of screen capture according to an embodiment of the disclosure. Operations of an electronic device to be described later may be performed by the first electronic device 101 of FIG. 1 or the processor 140 of the first electronic device 101.

Referring to FIG. 4, drawing 400 shows that the electronic device may display a first user interface (or a first UI) 410 on a display (e.g., the first display 110 of FIG. 1) in response to obtaining an image (or, capture image) obtained by capturing a screen. For example, the first UI 410 may include a function menu 411 including a list of functions subsequent to a screen capture function. For example, the function menu 411 may include a first icon 413 for executing a function of sharing a capture image. The function menu 411 may provide various functions in addition to a capture image sharing function. For example, the function menu 411 may further provide a function of writing text or drawing a picture on the capture image and/or a function of adding a hashtag (e.g., a keyword) to the capture image.

The electronic device may display a second user interface (or, a second UI) 420 on the display in response to receiving a user input (e.g., a touch input) for selecting the first icon 413. For example, the second UI 420 may include a preview image 421 of the capture image. For example, the second UI 420 may include a sub-user interface 423 that provides a function (or an option) of capturing the execution context of at least one application running on the electronic device. The sub-user interface 423 may include a second icon 425 for executing a function of capturing a context at the time of screen capture. For example, the sub-user interface 423 may further include information (e.g., the number and/or sizes of image files) about the capture image.

For example, in response to receiving a user input (e.g., a touch input) for selecting the second icon 425, the electronic device may obtain and store identification information of at least one application running on the electronic device at the time of the screen capture, location information indicating a location where an execution screen of the at least one application is displayed, and/or contextual information about an execution context of the at least one application. For example, the electronic device may store identification information, location information, and/or contextual information of at least one application as metadata of the capture image. For example, the electronic device may store identification information, location information, and/or contextual information of at least one application in the extension form of EXIF. A file including the capture image, and the identification information, the location information, and/or the contextual information, which is the metadata (or extension data) of the capture image, may be referenced as a “capture image file”.

The electronic device may store the capture image file in memory (e.g., the first memory 130 in FIG. 1) of the electronic device. For example, the electronic device may transmit and store the capture image file to a cloud server (e.g., the cloud server 105 of FIG. 1) through a communication circuit (e.g., the first communication circuit 120 of FIG. 1).

Although not shown in FIG. 4, for example, the electronic device may transmit the capture image file to another user terminal through the communication circuit in response to receiving a user input for directly sharing the capture image file with the other user terminal (e.g., the second electronic device 102 of FIG. 1). For example, the electronic device may transmit a message including the capture image file as an attached file to the other user terminal through a messaging application. For example, the electronic device may transmit the capture image file to the other user terminal, which is in proximity to the electronic device within a specified range, through Bluetooth™ or Wi-Fi™ Direct.

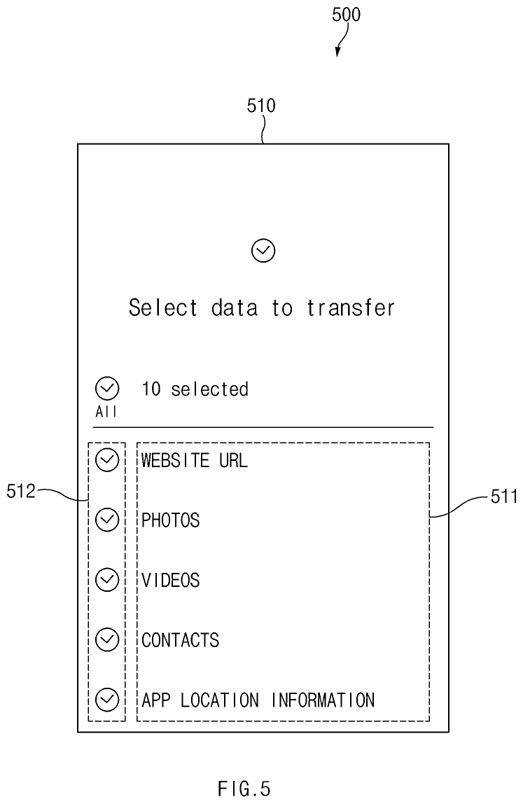

FIG. 5 is a drawing showing an example of a user interface, which is provided by an electronic device and which is used to select data to be transmitted before a capture image file is shared according to an embodiment of the disclosure. Operations of an electronic device to be described later may be performed by the first electronic device 101 of FIG. 1 or the processor 140 of the first electronic device 101.

Referring to FIG. 5, drawing 500 shows that, in response to receiving a user input for sharing a capture image file, the electronic device may display a user interface (or UI) 510 on a display (e.g., the first display 110 of FIG. 1). For example, the UI 510 may include a list 511 of data, which is included in a capture image file and which is to be transmitted. The data list to be transmitted may be referenced as a metadata list of the capture image to be transmitted. The metadata list may include a list of identification information, location information, and/or contextual information of at least one application.

Referring to FIG. 5, the list 511 of data to be transmitted may include, for example, a website URL, photos, videos, contacts, and app location information. Here, the contextual information may include the website URL, the photos, the videos, and the contacts. For example, the website URL may be contextual information obtained in response to an application displaying a website or a webpage, or an execution screen of the application displaying a website or a webpage. For example, the photos may be contextual information obtained in response to an application being a gallery application or an execution screen of the application being a screen showing a photo. For example, the videos may be contextual information obtained in response to an application being a video player application or an execution screen of the application being a video playback screen. For example, the contacts may be contextual information obtained in response to an application being a contact application or an execution screen of the application including contact information. The app location information may indicate a location at which the execution screen of each application is displayed on a display.

For example, the UI 510 may include a check box UI 512 corresponding to each of data items included in the list 511 of data to be transmitted. As illustrated in FIG. 5, for example, the electronic device may display, as a default state, the fact that all check boxes included in the check box UI 512 are selected. The electronic device may receive a user input for selecting data, which does not need to be transmitted, from the check box UI 512. For example, the user input for selecting data, which does not need to be transmitted, may include input for selecting a check box corresponding to each data item included in the check box UI 512.

The electronic device may share data other than data selected by the corresponding user input in response to the user input for selecting data, which does not need to be transmitted. For example, a shared capture image file may include data selected in the UI 510 and may exclude data not selected in the UI 510.

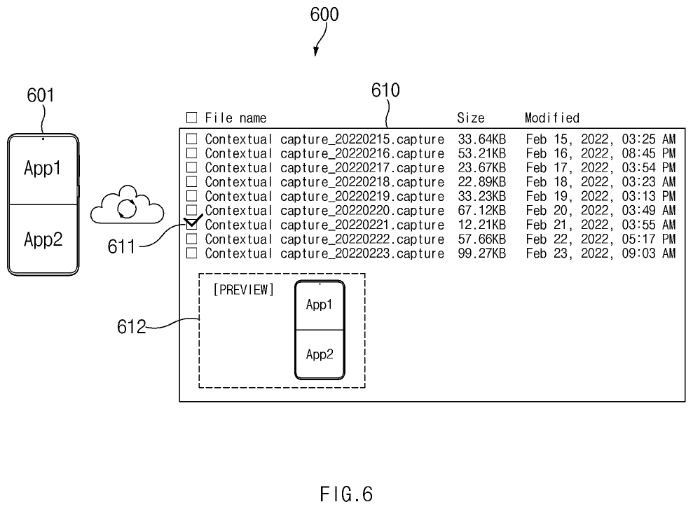

FIG. 6 is a drawing showing an example in which an electronic device manages a list of capture image files through a cloud server according to an embodiment of the disclosure. An electronic device 601 of FIG. 6 may be, for example, the first electronic device 101 of FIG. 1.

Referring to FIG. 6, drawing 600 shows that an electronic device 601 may list capture image files in a list organized at each capture time so as to be stored. For example, the electronic device 601 may generate a list of capture image files obtained by listing the capture image files at each capture time. For example, the electronic device 601 may upload and manage a list of capture image files to a cloud server (e.g., the cloud server 105 of FIG. 1), but is not limited thereto. For example, the electronic device 601 may also manage the list of capture image files within a device (the electronic device 601).

The cloud server may manage a list of capture image files and may provide the electronic device 601 with a service for uploading or downloading the capture image files. For example, the cloud server may provide a user interface 610 to the electronic device 601. For example, the electronic device 601 may display the user interface 610 on a display (e.g., the first display 110 of FIG. 1).

The user interface 610 may include the list of capture image files. For example, the list of capture image files may include capture image files sorted by file name, file size, or information about date and time at which a file is modified. The user interface 610 may provide a check box UI for selecting a capture image file item included in a list of capture image files.

For example, the electronic device 601 may provide a preview 612 of a capture image included in a first capture image file in response to receiving a user input for selecting a first check box 611 corresponding to the first capture image file.

The electronic device 601 may download at least one capture image file corresponding to at least one check box selected by the user input.

In response to the electronic device 601 uploading a capture image file to the cloud server, the uploaded capture image file may be added to the list of capture image files, and an item corresponding to the uploaded capture image file may be added to the user interface 610.

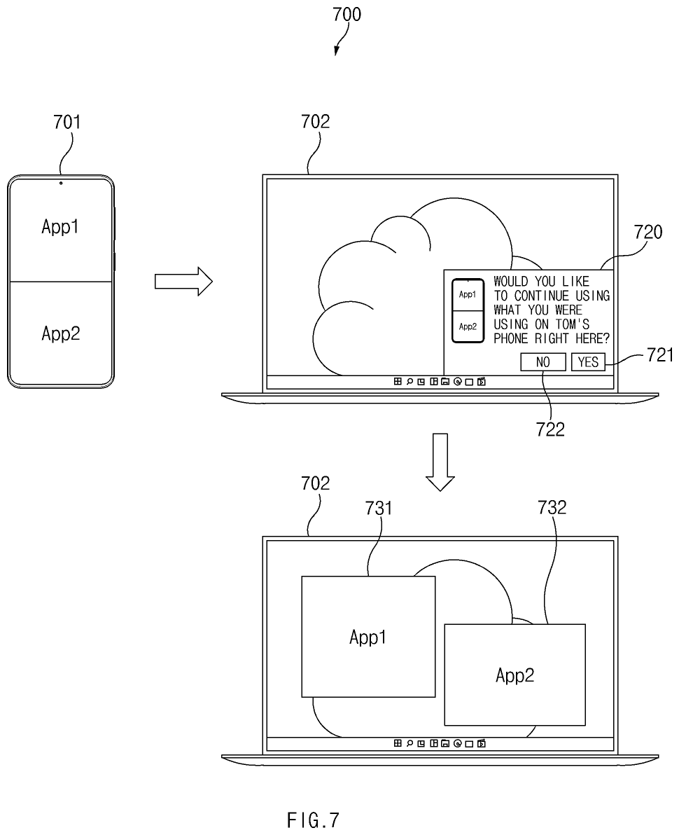

FIG. 7 is a drawing showing an example in which an electronic device shares a capture image file to an external electronic device according to an embodiment of the disclosure. For example, an electronic device 701 of FIG. 7 may be the first electronic device 101 of FIG. 1, and an external electronic device 702 of FIG. 7 may be the second electronic device 102.

Referring to FIG. 7, for example, drawing 700 shows that an electronic device 701 may be executing a first application (or a first app) (e.g., App 1) and a second application (or a second app) (e.g., App 2). For example, the electronic device 701 may be displaying an execution screen of the first app and an execution screen of the second app as a multi-window screen on a display (e.g., the first display 110 of FIG. 1).

The electronic device 701 may obtain an image (or a capture image) obtained by capturing a screen including the execution screen of the first app and the execution screen of the second app in response to receiving a user input for capturing the screen displayed on the display.

The electronic device 701 may obtain identification information of each of the first app and the second app running on the electronic device 701 at a point in time when the capture image is obtained. The electronic device 701 may obtain location information indicating a location, where the execution screen of the first app is displayed, and a location where the execution screen of the second app is displayed. The electronic device 701 may obtain contextual information about the execution context of the first app and contextual information about the execution context of the second app.

The electronic device 701 may store a capture image file including the capture image, identification information of each of the first app and the second app, location information of each of the first app and the second app, and/or contextual information of each of the first app and the second app in memory (e.g., the first memory 130 of FIG. 1) of the electronic device or a cloud server (e.g., the cloud server 105 of FIG. 1).

For example, the electronic device 701 may transmit a notification to an external electronic device 702 in response to receiving a user input for sharing the capture image file with the external electronic device 702. For example, in response to the electronic device 701 uploading the capture image file onto the cloud server, the cloud server may transmit a notification to the external electronic device 702 registered with the same user account as the electronic device 701.

The external electronic device 702 may provide a user interface 720 for accepting or rejecting the sharing (sending or downloading) of the capture image file in response to receiving the notification from the electronic device 701 or the cloud server. For example, the external electronic device 702 may display the user interface 720 on the display.

For example, the user interface 720 may include text for querying whether to receive the sharing of the capture image file of the electronic device 701, a sharing acceptance button 721, and a sharing rejection button 722. For example, the user interface 720 may include a preview image of a capture image.

The external electronic device 702 sharing the capture image file of the electronic device 701 may mean that the external electronic device 702 reproduces the execution state of at least one application (e.g., the first app and the second app) through the display of the external electronic device 702 at the time of screen capture of the electronic device 701.

The external electronic device 702 may launch the first app and the second app in response to receiving a user input for selecting the sharing acceptance button 721. For example, the external electronic device 702 may execute the first app and the second app based on identification information of each of the first app and the second app included in the capture image file. For example, the external electronic device 702 may execute the first app and the second app of the versions supported by the external electronic device 702. For example, when the first app or the second app is not installed (or stored) in the external electronic device 702, the external electronic device 702 may provide an installation link of the corresponding app. For example, when the first app or the second app is not installed (or stored) in the external electronic device 702, and the external electronic device 702 is located within a specified range (e.g., a mirrorable distance or radius) from the electronic device 701, the external electronic device 702 may mirror and display the execution screen of the corresponding app displayed on the display of the electronic device 701.

The external electronic device 702 may display an execution screen 731 of the first app and an execution screen 732 of the second app in response to receiving a user input for selecting the sharing acceptance button 721. Although not shown in FIG. 7, the external electronic device 702 may display the execution screen 731 of the first app and the execution screen 732 of the second app on the display of the external electronic device 702 so as to correspond to location information of each of the first app and the second app included in the capture image file. For example, the location information of each of the first app and the second app may include an aspect ratio of an execution screen of each app (e.g., the first app or the second app) displayed on the display of the electronic device 701 and/or a layout of execution screens of a plurality of apps (e.g., the first app and the second app) displayed on the display of the electronic device 701.

For example, on the basis of the location information indicating that the aspect ratio of the execution screen of the first app or the second app displayed on the display of the electronic device 701 is 16:9, the external electronic device 702 may display the execution screen 731 of the first app or the execution screen 732 of the second app as 16:9.

For example, on the basis of the location information indicating that the layout of the execution screens of the first app and the second app displayed on the display of the electronic device 701 is split into two parts while the first app is on top and the second app is on the bottom, the external electronic device 702 may vertically split the display area of the display into two parts while the execution screen 731 of the first app is on top and the execution screen 732 of the second app is on the bottom.

Although not shown in FIG. 7, the external electronic device 702 may display the execution screen 731 of the first app and the execution screen 732 of the second app on the display of the external electronic device 702 so as to correspond to contextual information of each of the first app and the second app included in the capture image file. The external electronic device 702 may display the execution screen 731 of the first app so as to correspond to contextual information of the first app, and may display the execution screen 732 of the second app so as to correspond to contextual information of the second app.

For example, on the basis of the contextual information of the first app including a URL and location information (e.g., page information) of a web page, the external electronic device 702 may display a page corresponding to the corresponding location information of the web page corresponding to the corresponding URL as the execution screen 731 of the first app. For example, on the basis of the contextual information of the second app including a URL and playback time point information, the external electronic device 702 may display a playback screen of a web video corresponding to the corresponding URL as the execution screen 732 of the second app, and may play a video from a point in time corresponding to the corresponding playback time point information.

The external electronic device 702 may reproduce the execution state of each app running on the electronic device 701 by displaying the execution screen of each app so as to correspond to contextual information of each app. For example, the external electronic device 702 may continue executing the first app and the second app, which were running at the time of screen capture of the electronic device 701, from the execution status of each app at the time of screen capture of the electronic device 701.

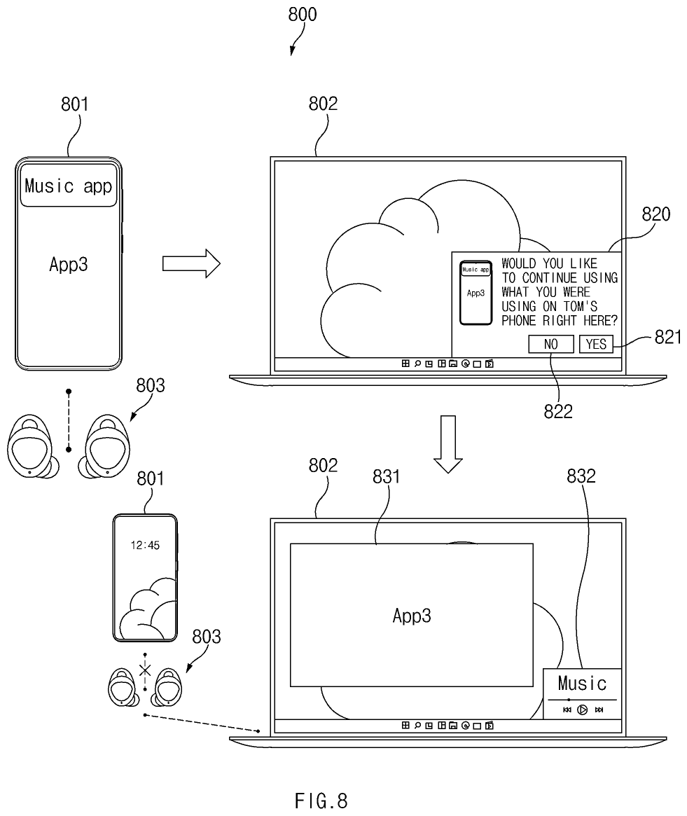

FIG. 8 is a drawing showing an example in which an electronic device shares a capture image file to an external electronic device according to an embodiment of the disclosure. For example, an electronic device 801 of FIG. 8 may be the first electronic device 101 of FIG. 1, and a second external electronic device 802 of FIG. 8 may be the second electronic device 102.

Referring to FIG. 8, for example, drawing 800 shows an electronic device 801 may be executing a third application (or a third app) (e.g., App 3) and a music application (or a music app) (e.g., Music app). For example, the electronic device 801 may display the execution screen of the third app and the execution screen of the music app as a multi-window screen on a display (e.g., the first display 110 or the second display 150 of FIG. 1). For example, the electronic device 801 may display the execution screen of the third app on a full screen and may display the execution screen of the music app in the form of a pop-up window.

The electronic device 801 may obtain an image (or a capture image) obtained by capturing a screen including the execution screen of the third app and the execution screen of the music app in response to receiving a user input for capturing the screen displayed on the display.

The electronic device 801 may obtain identification information of each of the third app and the music app running on the electronic device 801 at a point in time when the capture image is obtained, location information of each of the third app and the music app, and/or contextual information of each of the third app and the music app. For example, the location information may indicate that the execution screen of the third app is displayed on a full screen, and the execution screen of the music app is displayed in a pop-up window at the top of the full screen.

For example, at the time of screen capture, there may be a first external electronic device 803 connected to the electronic device 801. For example, the electronic device 801 may output music played in the music app through the first external electronic device 803. For example, the first external electronic device 803 may be an earphone or an earbud. For example, when there is the first external electronic device 803 connected to the electronic device 801 at the time of screen capture, the connected device information may be obtained as contextual information. The connected device information may be included in the contextual information of the music app.

The electronic device 801 may store a capture image file including the capture image, identification information of each of the third app and the music app, location information of each of the third app and the music app, and/or contextual information of each of the third app and the music app in memory (e.g., the first memory 130 of FIG. 1) of the electronic device or a cloud server (e.g., the cloud server 105 of FIG. 1).

For example, the electronic device 801 may transmit a notification to a second external electronic device 802 in response to receiving a user input for sharing the capture image file with the second external electronic device 802. For example, in response to the electronic device 801 uploading the capture image file onto the cloud server, the cloud server may transmit a notification to the second external electronic device 802 registered with the same user account as the electronic device 801.

The second external electronic device 802 may provide a user interface 820 for accepting or rejecting the sharing (sending or downloading) of the capture image file in response to receiving the notification from the electronic device 801 or the cloud server. For example, the second external electronic device 802 may display the user interface 820 on the display.

For example, the user interface 820 may include text for querying whether to receive the sharing of the capture image file of the electronic device 801, a sharing acceptance button 821, and a sharing rejection button 822. For example, the user interface 820 may include a preview image of a capture image.

The second external electronic device 802 sharing the capture image file of the electronic device 801 may mean that the second external electronic device 802 reproduces the execution state of at least one application (e.g., the third app and the music app) through the display of the second external electronic device 802 at the time of screen capture of the electronic device 801.

The second external electronic device 802 may execute the third app and the music app in response to receiving a user input for selecting the sharing acceptance button 821. The second external electronic device 802 may display an execution screen 831 of the third app and an execution screen 832 of the music app on the display in response to receiving a user input for selecting the sharing acceptance button 821. An operation of the external electronic device 702 of FIG. 7 executing the first app and the second app and displaying the execution screen of the first app and the execution screen of the second app may be applied identically or similarly to an operation of the second external electronic device 802 of FIG. 8 executing the third app and the music app and displaying the execution screen of the third app and the execution screen of the music app.

The second external electronic device 802 may display the execution screen 831 of the third app and the execution screen 832 of the music app on the display of the second external electronic device 802 so as to correspond to the location information of each of the third app and the music app included in the capture image file. For example, on the basis of location information indicating that the execution screen of the third app is displayed on the display of the electronic device 801 in a form of the full screen and the execution screen of the music app is displayed in a form of a pop-up window, the second external electronic device 802 may display the execution screen of the third app on the full screen (or a large screen equivalent thereto) and the execution screen of the music app in the form of a pop-up window.

The second external electronic device 802 may display the execution screen 831 of the third app so as to correspond to the contextual information of the third app, and may display the execution screen 832 of the music app so as to correspond to contextual information of the music app. For example, on the basis of contextual information of the music app including a music file and playback time point information, the second external electronic device 802 may play the corresponding music file on the execution screen of the music app. At this time, the second external electronic device 802 may play music from a time point corresponding to the corresponding playback time point information.

For example, on the basis of contextual information of the music app including device information of the first external electronic device 803, the second external electronic device 802 may establish a communication connection with the first external electronic device 803 and may output music played on the music app through the first external electronic device 803.

For example, when the electronic device 801 and the second external electronic device 802 are registered in the cloud server with the same user account, the electronic device 801 and the second external electronic device 802 may share device information (e.g., device information of the first external electronic device 803) connected to each electronic device with each other. In this case, the second external electronic device 802 may be connected to the first external electronic device 803 without performing a pairing process with the first external electronic device 803.

For example, as sharing the capture image file with the second external electronic device 802, the electronic device 801 may be disconnected from the first external electronic device 803. For example, the electronic device 801 may release the connection with the first external electronic device 803 in response to receiving a notification that the second external electronic device 802 accepts the sharing of a capture image file, from the second external electronic device 802 or a cloud server.

For example, as the music app running on the electronic device 801 continues to run on the second external electronic device 802, an audio path of the first external electronic device 803 may automatically change from the electronic device 801 to the second external electronic device 802.

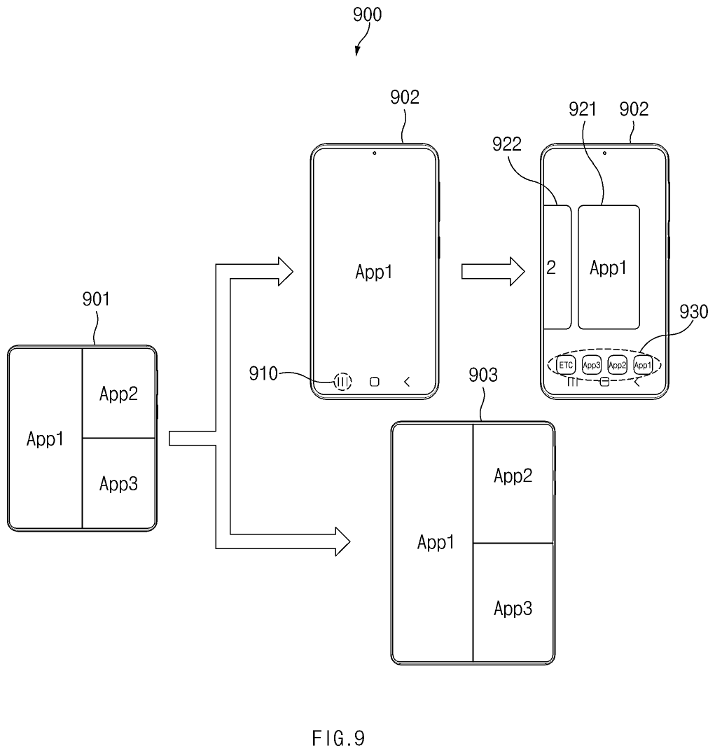

FIG. 9 is a drawing showing an example in which an electronic device shares a capture image file to an external electronic device according to an embodiment of the disclosure. For example, an electronic device 901 of FIG. 9 may be the first electronic device 101 of FIG. 1, and a first external electronic device 902 or a second external electronic device 903 of FIG. 9 may be the second electronic device 102.

Referring to FIG. 9, for example, drawing 900 shows that an electronic device 901 may be executing a first application (or a first app) (e.g., App 1), a second application (or a second app) (e.g., App 2), and a third application (or a third app) (e.g., App 3). For example, the electronic device 901 may be displaying an execution screen of the first app, an execution screen of the second app, and an execution screen of the third app as a multi-window screen on a display (e.g., the first display 110 of FIG. 1).

The electronic device 901 may obtain an image (or a capture image) obtained by capturing a screen including the execution screen of the first app, the execution screen of the second app, and the execution screen of the third app in response to receiving a user input for capturing the screen displayed on the display.

The electronic device 901 may obtain identification information of each of the first app, the second app, and the third app running on the electronic device 901 at a point in time when the capture image is obtained, location information of each of the first app, the second app, and the third app, and/or contextual information of each of the first app, the second app, and the third app. For example, the location information may include the layout of the execution screen of the first app, the execution screen of the second app, and the execution screen of the third app. For example, referring to FIG. 9, the location information may indicate that the execution screen of the first app is displayed in the left area of a vertically split area, the execution screen of the second app is displayed in the upper area of a horizontally split area in the right area of the vertically split area, and the execution screen of the third app is displayed in the lower area of the horizontally split area in the right area of the vertically split area.

The electronic device 901 may store a capture image file including the capture image, identification information of each of the first app, the second app, and the third app, location information of each of the first app, the second app, and the third app, and/or contextual information of each of the first app, the second app, and the third app in memory (e.g., the first memory 130 of FIG. 1) of the electronic device or a cloud server (e.g., the cloud server 105 of FIG. 1). The electronic device 901 may share the capture image file to an external electronic device directly or through the cloud server.

For example, the electronic device 901 may transmit the capture image file to the first external electronic device 902. For example, the first external electronic device 902 may be an electronic device that does not support a multi-window screen. The first external electronic device 902 may display an execution screen (e.g., the execution screen of the first app) of one of a plurality of apps on the display. For example, the first external electronic device 902 may display an icon 910 for executing a function of displaying a list of recently executed applications at the bottom of a screen. The first external electronic device 902 may display the list of recently executed applications on the display in response to receiving a user input for selecting the icon 910. The list of recently executed applications may include a plurality of apps (e.g., the first app, the second app, and the third app) that have running at a point in time when the capture image file received from the electronic device 901 is captured.

For example, the first external electronic device 902 may display a list of recently executed applications by displaying the execution screen (e.g., an execution screen 921 of the first app or an execution screen 922 of the second app) of each app in a form that is minimally arranged side by side. For example, the first external electronic device 902 may display the execution screen of the second app on the display in response to receiving a user input for selecting the execution screen 922 of the second app.

For example, the first external electronic device 902 may display a list of recently executed applications by displaying an icon collection 930 including an icon indicating each app. For example, the first external electronic device 902 may display an execution screen of the third app on the display in response to receiving a user input for selecting an icon indicating the third app.

For example, the electronic device 901 may transmit the capture image file to the second external electronic device 903. For example, the second external electronic device 903 may be an electronic device that supports a multi-window screen. For example, the second external electronic device 903 may be an electronic device that supports a multi-window screen with the same layout as the screen captured from the electronic device 901. For example, the second external electronic device 903 may display the execution screen of the first app, the execution screen of the second app, and the execution screen of the third app on the display based on the location information of each of the first app, the second app, and the third app. For example, on the basis of location information indicating that the execution screen of the first app is displayed in the left area of the vertically split area, the execution screen of the second app is displayed in the upper area of the horizontally split area of the right area in the vertically split area, and the execution screen of the third app is displayed in the lower area of the horizontally split area in the right area of the vertically split area, the second external electronic device 903 may vertically split the display area of the display, may display the execution screen of the first app in the left area of the vertically split area, may horizontally split the right area of the vertically split area, may display the execution screen of the second app in the upper area of the horizontally split right area, and may display the execution screen of the third app in the lower area of the horizontally split right area. For example, the second external electronic device 903 may display the execution screen of the first app, the execution screen of the second app, and the execution screen of the third app on the display in a layout identical or similar to that of the screens captured by the electronic device 901.

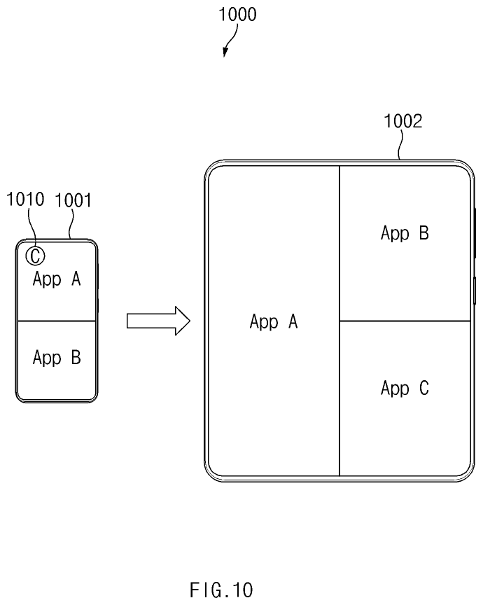

FIG. 10 is a drawing showing an example in which an electronic device shares a capture image file to an external electronic device according to an embodiment of the disclosure. For example, an electronic device 1001 of FIG. 10 may be the first electronic device 101 of FIG. 1, and an external electronic device 1002 of FIG. 10 may be the second electronic device 102.

Referring to FIG. 10, for example, drawing 1000 shows that an electronic device 1001 may be executing application A (or an app ‘A’ (e.g., App A)), application B (or an app ‘B’) (e.g., App B), and application C (or an app ‘C’) (e.g., App C). For example, the electronic device 1001 may be displaying an execution screen of the app ‘A’ and an execution screen of the app ‘B’ as a multi-window screen on a display (e.g., the first display 110 of FIG. 1). For example, the electronic device 1001 may not display the execution screen of the app ‘C’, but may display an icon 1010 minimally indicating that the app ‘C’ is running.

The electronic device 1001 may obtain an image (or a capture image) obtained by capturing a screen including the execution screen of the app ‘A’ and the execution screen of the app ‘B’ in response to receiving a user input for capturing the screen displayed on the display.

The electronic device 1001 may obtain identification information of each of the first app, the second app, and the third app running on the electronic device 1001 at a point in time when the capture image is obtained. The electronic device 1001 may obtain location information of each of the first app and the second app running on the electronic device 1001 at a point in time when the capture image is obtained. The electronic device 1001 may obtain contextual information of each of the first app, the second app, and the third app running on the electronic device 1001 at a point in time when the capture image is obtained. For example, the electronic device 1001 may obtain only identification information and/or contextual information of the app ‘C’, without obtaining location information about the app ‘C’. For example, the obtained location information of a plurality of apps may include the layout of the execution screen of the first app and the execution screen of the second app.

For example, the electronic device 1001 may store a capture image file including the capture image, identification information of each of the first app, the second app, and the third app, location information of each of the first app, the second app, and the third app, and/or contextual information of each of the first app, the second app, and the third app in memory (e.g., the first memory 130 of FIG. 1) of the electronic device or a cloud server (e.g., the cloud server 105 of FIG. 1). The electronic device 1001 may share the capture image file to the external electronic device 1002 directly or through the cloud server.

For example, the electronic device 1001 may transmit the capture image file to the external electronic device 1002. For example, the external electronic device 1002 may support a multi-window screen. For example, the number of split screens supported by the external electronic device 1002 may be greater than the number of split screens supported by the electronic device 1001. For example, the number of split screens supported by the external electronic device 1002 may be greater than or equal to the number (e.g., 3) of applications running on the electronic device 1001 at a point in time when the capture image file received from the electronic device 1001 is captured. For example, the external electronic device 1002 may support a 3-split multi-window screen. For example, the external electronic device 1002 may create a multi-window screen including the execution screen of an app (e.g., the execution screen of app ‘C’) that is not displayed on the display of the electronic device 1001 at the time of screen capture and may display the multi-window screen.

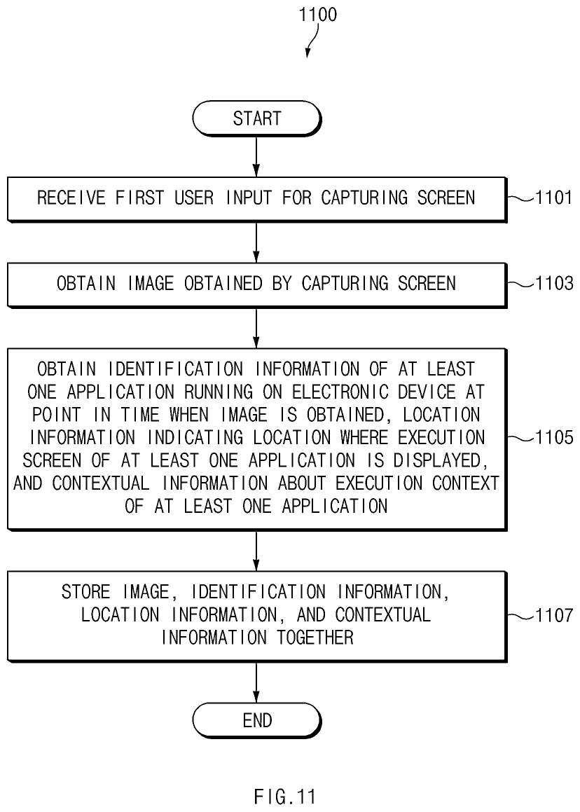

FIG. 11 is a flowchart illustrating an operation of an electronic device, according to an example according to an embodiment of the disclosure. For example, operations of an electronic device to be described later may be performed by the first electronic device 101 of FIG. 1 or the first processor 140 of the first electronic device 101.

Referring to FIG. 11, flowchart 1100 illustrates that, in operation 1101, the electronic device may receive a first user input for capturing a screen. The electronic device may receive a first user input for capturing the screen being displayed on a display (e.g., the first display 110 of FIG. 1). For example, the first user input may be an input for simultaneously pressing two buttons formed side by side on the side housing of the electronic device, or a gesture input for swiping the display from one side to the opposite side.

In operation 1103, the electronic device may obtain an image obtained by capturing the screen. The electronic device may obtain an image obtained by capturing the screen in response to the first user input. The image obtained by capturing the screen may be, for example, a still image. In the disclosure, the image obtained by capturing the screen may be referred to as a “capture image”.

In operation 1105, the electronic device may obtain identification information of at least one application running on the electronic device at a point in time when an image is obtained, location information indicating a location where an execution screen of the at least one application is displayed, and contextual information about an execution context of the at least one application.

The identification information may be information for identifying an application and may include, for example, a name, an identifier (ID), and/or a classification code. For example, when the captured screen is a multi-window screen including execution screens of a plurality of applications, the electronic device may obtain the identification information of each of the plurality of applications.

For example, the location information may include a ratio of each execution screen and/or the layout of at least one execution screen. In the disclosure, the ratio of each execution screen may be referenced as an aspect ratio of each execution screen. In the disclosure, the layout may indicate a location and a size where at least one execution screen is arranged on a display area of the display. For example, when the captured screen is a multi-window screen including execution screens of a plurality of applications, the electronic device may obtain a layout indicating a screen dividing method for the multi-window screen.

The electronic device may obtain contextual information about the execution context of at least one application. For example, when the captured screen is a multi-window screen including execution screens of the plurality of applications, the electronic device may obtain the contextual information of each of the plurality of applications. The electronic device may be configured to collect the corresponding contextual information for each application or information included in the execution screen of an application. For example, when there is contextual information set to be collected with respect to the running application, the electronic device may obtain the contextual information corresponding to the running application.

In operation 1107, the electronic device may store an image, identification information, location information, and contextual information together. The electronic device may store the identification information, the location information, and the contextual information as metadata of the image. For example, the electronic device may store the captured image in an EXIF format by adding the identification information, the location information, and the contextual information to the metadata of the image. A file including the image, and the identification information, the location information, and/or the contextual information, which is the metadata of the image, may be referenced as a “capture image file”.

For example, the electronic device may transmit the image, the identification information, the location information, and the contextual information to the cloud server (e.g., the cloud server 105 of FIG. 1) through a communication circuit (e.g., the first communication circuit 120). For example, the image, the identification information, the location information, and the contextual information may be listed and stored on the cloud server at each capture time. For example, the cloud server may manage a list of capture image files and may provide the electronic device with a service for uploading or downloading the capture image files.

For example, the electronic device may establish a communication connection with an external electronic device (e.g., the second electronic device 102 of FIG. 1) in proximity to the electronic device through the communication circuit. The electronic device may transmit the image, the identification information, the location information, and the contextual information to the external electronic device. For example, the electronic device may communicate with the external electronic device located within a specified range (e.g., a distance or a radius) of the electronic device through Bluetooth™ or Wi-Fi™ Direct. For example, the electronic device may transmit a notification to the external electronic device in response to receiving a user input for sharing the capture image file. For example, the electronic device may transmit the capture image file in response to receiving a notification for accepting the sharing (or transfer) of the capture image file from the external electronic device.

For example, after the image obtained by capturing the screen is captured, the electronic device may receive a second user input for sharing the image, the identification information, the location information, and the contextual information. The electronic device may display a list of data to be transmitted in response to the second user input. For example, the electronic device may receive a third user input for selecting data, which does not need to be transmitted, from the data list to be transmitted. The electronic device may transmit data other than data selected by the third user input to the external electronic device in response to the third user input.

For example, when there is a first external electronic device connected to the electronic device through the communication circuit at a point in time when the image obtained by capturing the screen is captured, the electronic device may connect the first external electronic device to the second external electronic device in response to receiving a user input for transmitting the image, the identification information, the location information, and the contextual information to the second external electronic device. For example, as the electronic device shares the capture image file with the second external electronic device, the electronic device may disconnect the electronic device from the first external electronic device and may connect the first external electronic device to the second external electronic device. For example, when the electronic device and the second external electronic device are registered in the cloud server with the same user account, the second external electronic device may be connected to the first external electronic device without performing a pairing process with the first external electronic device.

For example, when a first application is executing at a point in time when an image obtained by capturing a screen is obtained, and the execution screen of the first application is not displayed on the display, the electronic device may obtain identification information and contextual information about the first application. The electronic device may store the image and, identification information and contextual information about the first application. For example, on the display of an electronic device, the execution screen of the first application may not be displayed, but an icon indicating that the first application is running may be minimally displayed. In this case, the electronic device may fail to obtain location information about the first application. The electronic device may only obtain identification information and/or contextual information of the first application.

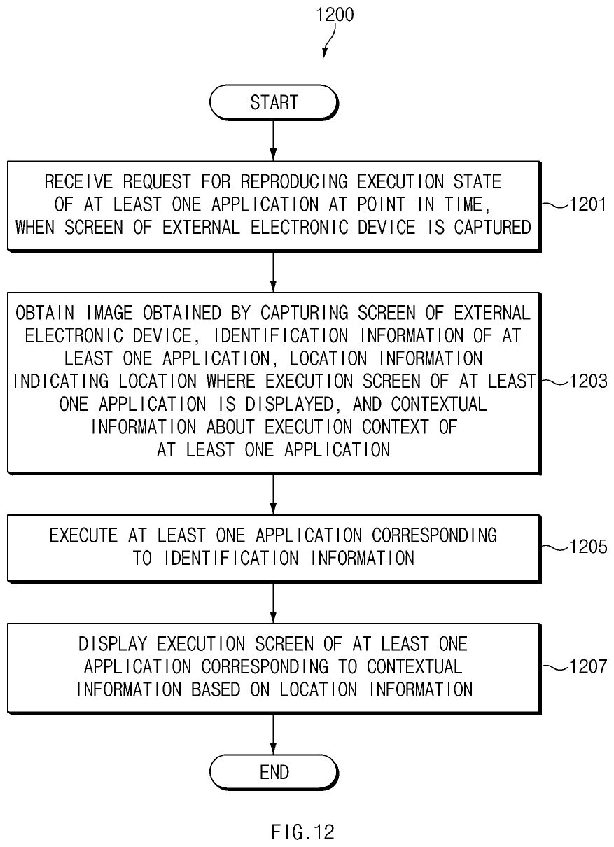

FIG. 12 is a flowchart illustrating an operation of an electronic device, according to an example according to an embodiment of the disclosure. For example, operations of an electronic device to be described later may be performed by the second electronic device 102 of FIG. 1 or the second processor 180 of the second electronic device 102.

Referring to FIG. 12, flowchart 1200 illustrates that, in operation 1201, the electronic device may receive a request for reproducing the execution state of at least one application at a point in time, when a screen of an external electronic device (e.g., the first electronic device 101 of FIG. 1) is captured. The electronic device may receive the request for reproducing the execution state of at least one application at the time of screen capture of the external electronic device through a communication circuit (e.g., the second communication circuit 160 of FIG. 1). For example, the request may be a request for the sharing of a capture image file.

For example, the electronic device may receive the request for sharing of the capture image file from the external electronic device or a cloud server. For example, the request for the sharing of the capture image file may be included in a notification transmitted to the electronic device by the external electronic device in response to receiving a user input for sharing the capture image file. For example, the request for the sharing of the capture image file may be included in a notification transmitted by the cloud server to the electronic device, which is registered with the same user account as the external electronic device, in response to receiving the capture image file from the external electronic device.

In operation 1203, the electronic device may obtain an image obtained by capturing a screen of an external electronic device, identification information of at least one application, location information indicating a location where an execution screen of the at least one application is displayed, and contextual information about an execution context of the at least one application. The electronic device may receive an image, the identification information, the location information, and the contextual information through the communication circuit in response to receiving a user input for accepting a request for reproducing an execution state of at least one application at the time of screen capture of the external electronic device. For example, the electronic device may receive a capture image file from the external electronic device or the cloud server in response to receiving the user input for accepting the request for the sharing of the capture image file.

In operation 1205, the electronic device may execute at least one application corresponding to the identification information. For example, the electronic device may launch the at least one application as an application of a version supported by the electronic device. For example, when an application corresponding to the identification information is not installed (or stored) in the electronic device, the electronic device may provide an installation link for the corresponding application. For example, when the application corresponding to the identification information is not installed (or stored) in the electronic device and an external electronic device is located within a specified range (e.g., a mirrorable distance or radius) from the electronic device, the electronic device may mirror the execution screen of the corresponding application displayed on a display (e.g., the first display 110) of the external electronic device and may display the mirrored result on a display (e.g., the second display 150).

In operation 1207, the electronic device may display the execution screen of at least one application corresponding to the contextual information based on the location information. The electronic device may display the execution screen of at least one application on the display (e.g., the second display 150) based on the location information. The execution screen of each application may correspond to contextual information of each application.

For example, the electronic device may display the execution screen of the at least one application on the display (e.g., the second display 150) such that a ratio of the execution screen of each application corresponds to a ratio of an execution screen displayed on the display (e.g., the first display 110) of the external electronic device.

For example, the electronic device may display the execution screen of the at least one application on the display (e.g., the second display 150) such that the execution screen of each application corresponds to the location and size of the display area of the display (e.g., the first display 110) of the external electronic device.

For example, when the captured screen of the external electronic device includes execution screens of a plurality of applications, and the electronic device is incapable of displaying the execution screens of the plurality of applications on one screen, the electronic device may display the execution screen of one of the plurality of applications on the display (e.g., the second display 150). For example, the electronic device may provide a list of the plurality of applications including the execution screen displayed on the display and the other execution screens not displayed on the display, in response to a user input for identifying a list of recently executed applications.

For example, when the captured screen of the external electronic device includes the execution screens of the plurality of applications, and the electronic device is capable of displaying the execution screens of the plurality of applications on one screen, the electronic device may display the execution screens of the plurality of applications on the display (e.g., the second display 150) based on location information. For example, the location information may include the layout of the execution screens of the plurality of applications (or a screen dividing method of the multi-window screen). For example, the electronic device may display the execution screens of the plurality of applications on the display (e.g., the second display 150) such that the layout of the execution screens of the plurality of applications corresponds to the layout displayed on the display (e.g., the first display 110) of the external electronic device.

For example, when the number of applications running on the external electronic device is greater than the number of split screens supported by the external electronic device at the time of screen capture, the external electronic device may display only some execution screens of the plurality of applications, which are running on the display (e.g., the first display 110). For example, the capture image file received from an external electronic device by the electronic device may include identification information and/or contextual information of an application whose execution screen is not displayed on the display of the external electronic device. For example, when the number of split screens supported by the electronic device is greater than the number of split screens supported by the external electronic device, the electronic device may create the multi-window screen including the execution screen of the application that is not displayed on the display of the external electronic device at the time of screen capture and may display the multi-window screen on the display (e.g., the second display 150).

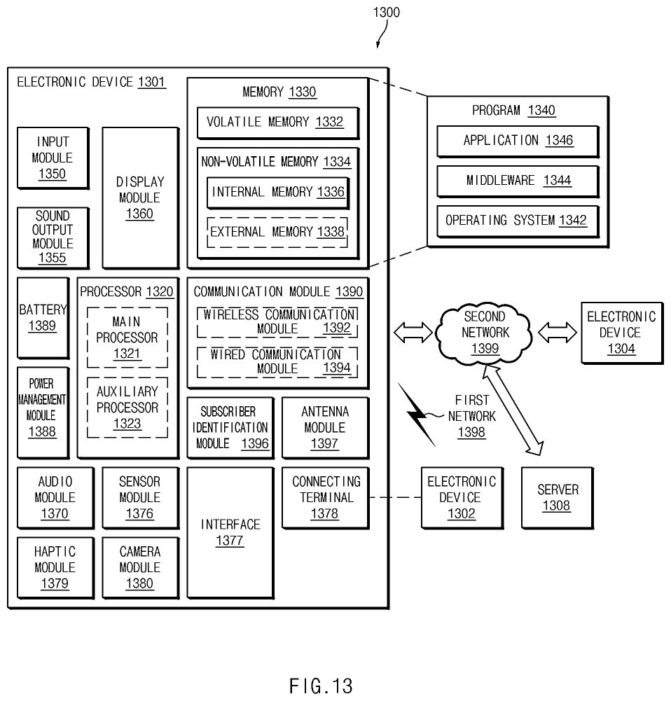

Hereinafter, an electronic device 1301 of FIG. 13 may correspond to the first electronic device 101 or the second electronic device 102 of FIG. 1.

FIG. 13 is a block diagram illustrating an electronic device in a network environment according to an embodiment of the disclosure.

Referring to FIG. 13, an electronic device 1301 in a network environment 1300 may communicate with an electronic device 1302 via a first network 1398 (e.g., a short-range wireless communication network), or at least one of an electronic device 1304 or a server 1308 via a second network 1399 (e.g., a long-range wireless communication network). According to an embodiment, the electronic device 1301 may communicate with the electronic device 1304 via the server 1308. According to an embodiment, the electronic device 1301 may include a processor 1320, memory 1330, an input module 1350, a sound output module 1355, a display module 1360, an audio module 1370, a sensor module 1376, an interface 1377, a connecting terminal 1378, a haptic module 1379, a camera module 1380, a power management module 1388, a battery 1389, a communication module 1390, a subscriber identification module (SIM) 1396, or an antenna module 1397. In some embodiments, at least one of the components (e.g., the connecting terminal 1378) may be omitted from the electronic device 1301, or one or more other components may be added in the electronic device 1301. In some embodiments, some of the components (e.g., the sensor module 1376, the camera module 1380, or the antenna module 1397) may be implemented as a single component (e.g., the display module 1360).

The processor 1320 may execute, for example, software (e.g., a program 1340) to control at least one other component (e.g., a hardware or software component) of the electronic device 1301 coupled with the processor 1320, and may perform various data processing or computation. According to one embodiment, as at least part of the data processing or computation, the processor 1320 may store a command or data received from another component (e.g., the sensor module 1376 or the communication module 1390) in volatile memory 1332, process the command or the data stored in the volatile memory 1332, and store resulting data in non-volatile memory 1334. According to an embodiment, the processor 1320 may include a main processor 1321 (e.g., a central processing unit (CPU) or an application processor (AP)), or an auxiliary processor 1323 (e.g., a graphics processing unit (GPU), a neural processing unit (NPU), an image signal processor (ISP), a sensor hub processor, or a communication processor (CP)) that is operable independently from, or in conjunction with, the main processor 1321. For example, when the electronic device 1301 includes the main processor 1321 and the auxiliary processor 1323, the auxiliary processor 1323 may be adapted to consume less power than the main processor 1321, or to be specific to a specified function. The auxiliary processor 1323 may be implemented as separate from, or as part of the main processor 1321.

The auxiliary processor 1323 may control at least some of functions or states related to at least one component (e.g., the display module 1360, the sensor module 1376, or the communication module 1390) among the components of the electronic device 1301, instead of the main processor 1321 while the main processor 1321 is in an inactive (e.g., sleep) state, or together with the main processor 1321 while the main processor 1321 is in an active state (e.g., executing an application). According to an embodiment, the auxiliary processor 1323 (e.g., an image signal processor or a communication processor) may be implemented as part of another component (e.g., the camera module 1380 or the communication module 1390) functionally related to the auxiliary processor 1323. According to an embodiment, the auxiliary processor 1323 (e.g., the neural processing unit) may include a hardware structure specified for artificial intelligence model processing. An artificial intelligence model may be generated by machine learning. Such learning may be performed, e.g., by the electronic device 1301 where the artificial intelligence is performed or via a separate server (e.g., the server 1308). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1330 may store various data used by at least one component (e.g., the processor 1320 or the sensor module 1376) of the electronic device 1301. The various data may include, for example, software (e.g., the program 1340) and input data or output data for a command related thereto. The memory 1330 may include the volatile memory 1332 or the non-volatile memory 1334.

The program 1340 may be stored in the memory 1330 as software, and may include, for example, an operating system (OS) 1342, middleware 1344, or an application 1346.

The input module 1350 may receive a command or data to be used by another component (e.g., the processor 1320) of the electronic device 1301, from the outside (e.g., a user) of the electronic device 1301. The input module 1350 may include, for example, a microphone, a mouse, a keyboard, a key (e.g., a button), or a digital pen (e.g., a stylus pen).

The sound output module 1355 may output sound signals to the outside of the electronic device 1301. The sound output module 1355 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1360 may visually provide information to the outside (e.g., a user) of the electronic device 1301. The display module 1360 may include, for example, a display, a hologram device, or a projector and control circuitry to control a corresponding one of the display, hologram device, and projector. According to an embodiment, the display module 1360 may include a touch sensor adapted to detect a touch, or a pressure sensor adapted to measure the intensity of force incurred by the touch.

The audio module 1370 may convert a sound into an electrical signal and vice versa. According to an embodiment, the audio module 1370 may obtain the sound via the input module 1350, or output the sound via the sound output module 1355 or a headphone of an external electronic device (e.g., the electronic device 1302) directly (e.g., wiredly) or wirelessly coupled with the electronic device 1301.

The sensor module 1376 may detect an operational state (e.g., power or temperature) of the electronic device 1301 or an environmental state (e.g., a state of a user) external to the electronic device 1301, and then generate an electrical signal or data value corresponding to the detected state. According to an embodiment, the sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used for the electronic device 1301 to be coupled with the external electronic device (e.g., the electronic device 1302) directly (e.g., wiredly) or wirelessly. According to an embodiment, the interface 1377 may include, for example, a high definition multimedia interface (HDMI), a universal serial bus (USB) interface, a secure digital (SD) card interface, or an audio interface.

The connecting terminal 1378 may include a connector via which the electronic device 1301 may be physically connected with the external electronic device (e.g., the electronic device 1302). According to an embodiment, the connecting terminal 1378 may include, for example, an HDMI connector, a USB connector, an SD card connector, or an audio connector (e.g., a headphone connector).

The haptic module 1379 may convert an electrical signal into a mechanical stimulus (e.g., a vibration or a movement) or electrical stimulus which may be recognized by a user via his tactile sensation or kinesthetic sensation. According to an embodiment, the haptic module 1379 may include, for example, a motor, a piezoelectric element, or an electric stimulator.

The camera module 1380 may capture a still image or moving images. According to an embodiment, the camera module 1380 may include one or more lenses, image sensors, image signal processors, or flashes.

The power management module 1388 may manage power supplied to the electronic device 1301. According to one embodiment, the power management module 1388 may be implemented as at least part of, for example, a power management integrated circuit (PMIC).

The battery 1389 may supply power to at least one component of the electronic device 1301. According to an embodiment, the battery 1389 may include, for example, a primary cell which is not rechargeable, a secondary cell which is rechargeable, or a fuel cell.

The communication module 1390 may support establishing a direct (e.g., wired) communication channel or a wireless communication channel between the electronic device 1301 and the external electronic device (e.g., the electronic device 1302, the electronic device 1304, or the server 1308) and performing communication via the established communication channel. The communication module 1390 may include one or more communication processors that are operable independently from the processor 1320 (e.g., the application processor (AP)) and supports a direct (e.g., wired) communication or a wireless communication. According to an embodiment, the communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device via the first network 1398 (e.g., a short-range communication network, such as Bluetooth™, wireless-fidelity (Wi-Fi™) direct, or infrared data association (IrDA)) or the second network 1399 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1392 may identify and authenticate the electronic device 1301 in a communication network, such as the first network 1398 or the second network 1399, using subscriber information (e.g., international mobile subscriber identity (IMSI)) stored in the subscriber identification module 1396.

The wireless communication module 1392 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1392 may support a high-frequency band (e.g., the millimeter wave (mmWave) band) to achieve, e.g., a high data transmission rate. The wireless communication module 1392 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1392 may support various requirements specified in the electronic device 1301, an external electronic device (e.g., the electronic device 1304), or a network system (e.g., the second network 1399). According to an embodiment, the wireless communication module 1392 may support a peak data rate (e.g., 20 gigabits per second (Gbps) or more) for implementing eMBB, loss coverage (e.g., 1364 decibels dB or less) for implementing mMTC, or U-plane latency (e.g., 0.5 milliseconds (ms) or less for each of downlink (DL) and uplink (UL), or a round trip of 13 ms or less) for implementing URLLC.

The antenna module 1397 may transmit or receive a signal or power to or from the outside (e.g., the external electronic device) of the electronic device 1301. According to an embodiment, the antenna module 1397 may include an antenna including a radiating element composed of a conductive material or a conductive pattern formed in or on a substrate (e.g., a printed circuit board (PCB)). According to an embodiment, the antenna module 1397 may include a plurality of antennas (e.g., array antennas). In such a case, at least one antenna appropriate for a communication scheme used in the communication network, such as the first network 1398 or the second network 1399, may be selected, for example, by the communication module 1390 (e.g., the wireless communication module 1392) from the plurality of antennas. The signal or the power may then be transmitted or received between the communication module 1390 and the external electronic device via the selected at least one antenna. According to an embodiment, another component (e.g., a radio frequency integrated circuit (RFIC)) other than the radiating element may be additionally formed as part of the antenna module 1397.

According to various embodiments, the antenna module 1397 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1301 and the external electronic device 1304 via the server 1308 coupled with the second network 1399. Each of the electronic devices 1302 or 1304 may be a device of a same type as, or a different type, from the electronic device 1301. According to an embodiment, all or some of operations to be executed at the electronic device 1301 may be executed at one or more of the external electronic devices (e.g., electronic devices 1302 and 1304 and server 1308). For example, if the electronic device 1301 should perform a function or a service automatically, or in response to a request from a user or another device, the electronic device 1301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1301. The electronic device 1301 may provide the outcome, with or without further processing of the outcome, as at least part of a reply to the request. To that end, a cloud computing, distributed computing, mobile edge computing (MEC), or client-server computing technology may be used, for example. The electronic device 1301 may provide ultra low-latency services using, e.g., distributed computing or mobile edge computing. In another embodiment, the external electronic device 1304 may include an internet-of-things (IoT) device. The server 1308 may be an intelligent server using machine learning and/or a neural network. According to an embodiment, the external electronic device 1304 or the server 1308 may be included in the second network 1399. The electronic device 1301 may be applied to intelligent services (e.g., smart home, smart city, smart car, or healthcare) based on 5G communication technology or IoT-related technology.

The electronic device 101, 301, 601, 701, 801, 901, 1001, or 1301 may provide a screen capture function. For example, the electronic device may store and share text or images included in a screen displayed on the display 110 or display module 1360 in the form of an image by using the screen capture function. An image (e.g., the capture image) obtained through the screen capture function simply shows a screen that is being displayed on the display of the electronic device at the time of screen capture. The electronic device or an external electronic device 102, 105, 702, 802, 902, 903, 1002, 1302, 1304, or 1308 receiving the sharing of the capture image from the electronic device may not reproduce the context of the electronic device at the time of screen capture. For example, the electronic device or the external electronic device receiving the sharing of the capture image from the electronic device may not reproduce the execution state of at least one application that was running on the electronic device at the time of screen capture.

Embodiments of the disclosure may provide an electronic device capable of reproducing the execution state of at least one application at the time of screen capture of the electronic device by storing and sharing the captured screen together with an execution context of at least one application running on the electronic device at the time of screen capture, an operating method, and a storage medium.

According to an embodiment of the disclosure, it is possible to allow another electronic device to continuously execute at least one application from the execution state of each application at the time of screen capture of the electronic device by sharing the execution context of at least one application at the time of screen capture of the electronic device.

According to an embodiment of the disclosure, an electronic device 101, 301, 601, 701, 801, 901, 1001, or 1301 may include a display 110 or display module 1360, a communication circuit 120 or communication module 1390, memory 130 or 1330, and a processor 140 or 1320. The memory may store instructions. When executed by the processor, the instructions cause, the electronic device to receive a first user input for capturing a screen being displayed on the display. When executed by the processor, the instructions may cause the electronic device to acquire an image, which is obtained by capturing the screen, in response to the first user input. When executed by the processor, the instructions may cause the electronic device to acquire identification information of at least one application running on the electronic device at a point in time when the image is acquired, location information indicating a location where an execution screen of the at least one application is displayed, and contextual information about an execution context of the at least one application. When executed by the processor, the instructions may cause the electronic device to store the image, the identification information, the location information, and the contextual information together.

According to an embodiment of the disclosure, when executed by the processor, the instructions may cause the electronic device to store the identification information, the location information, and the contextual information as metadata of the image.

According to an embodiment of the disclosure, when executed by the processor, the instructions may cause the electronic device to transmit the image, the identification information, the location information, and the contextual information to a cloud server 105 or server 1308 through the communication circuit. The image, the identification information, the location information, and the contextual information may be listed and stored in the cloud server at each capture time point.

According to an embodiment of the disclosure, when executed by the processor, the instructions may cause the electronic device to establish a communication connection with an external electronic device 102, 702, 802, 902, 903, 1002, or 1302 in proximity to the electronic device through the communication circuit. When executed by the processor, the instructions may cause the electronic device to transmit the image, the identification information, the location information, and the contextual information to the external electronic device.

According to an embodiment of the disclosure, when executed by the processor, the instructions may cause the electronic device to receive a second user input for sharing the image, the identification information, the location information, and the contextual information, after the image is acquired. When executed by the processor, the instructions may cause the electronic device to display a list of data to be transmitted on the display in response to the second user input. When executed by the processor, the instructions may cause the electronic device to receive a third user input for selecting data, which does not need to be transmitted, from among data included in the list. When executed by the processor, the instructions may cause the electronic device to transmit data, other than data selected in response to the third user input, to at least one of an external electronic device 102, 702, 802, 902, 903, 1002, 1302, or 1304 in response to the third user input.

According to an embodiment of the disclosure, when executed by the processor, the instructions may cause the electronic device to connect the first external electronic device with a second external electronic device 802 in response to receiving a user input for transmitting the image, the identification information, the location information, and the contextual information to the second external electronic device when there is a first external electronic device 803 connected to the electronic device through the communication circuit at the point in time when the image is acquired.

According to an embodiment of the disclosure, when executed by the processor, the instructions may cause the electronic device to obtain the identification information and the contextual information about the first application when a first application is executing at the point in time when the image is acquired, and an execution screen of the first application is not displayed on the display. When executed by the processor, the instructions may cause the electronic device to store the image and the identification information and the contextual information about the first application together.

According to an embodiment of the disclosure, an operating method of an electronic device 101, 301, 601, 701, 801, 901, 1001, or 1301 may include receiving a first user input for capturing a screen being displayed on a display 110 or display module 1360 of the electronic device. The method may include acquiring an image, which is obtained by capturing the screen, in response to the first user input. The method may include acquiring identification information of at least one application running on the electronic device at a point in time when the image is acquired, location information indicating a location where an execution screen of the at least one application is displayed, and contextual information about an execution context of the at least one application. The method may include storing the image, the identification information, the location information, and the contextual information together.

According to an embodiment of the disclosure, the storing of the identification information, the location information, and the contextual information may include storing the identification information, the location information, and the contextual information as metadata of the image.

According to an embodiment of the disclosure, the method may include transmitting the image, the identification information, the location information, and the contextual information to a cloud server 105 or server 1308 through a communication circuit 120 or communication module 1390 of the electronic device. The image, the identification information, the location information, and the contextual information may be listed and stored in the cloud server at each capture time point.

According to an embodiment of the disclosure, the method may include establishing a communication connection with an external electronic device 102, 702, 802, 902, 903, 1002, or 1302 in proximity to the electronic device through a communication circuit 120 or communication module 1390 of the electronic device. The method may include transmitting at least one of the image, the identification information, the location information, and the contextual information to the external electronic device.

According to an embodiment of the disclosure, the method may include receiving a second user input for sharing the image, the identification information, the location information, and the contextual information, after the image is acquired. The method may include displaying a list of data to be transmitted on the display in response to the second user input. The method may include receiving a third user input for selecting data, which does not need to be transmitted, from among data included in the list. The method may include transmitting data, other than data selected in response to the third user input, to an external electronic device 102, 105, 702, 802, 902, 903, 1002, 1302, 1304, or 1308 in response to the third user input.

According to an embodiment of the disclosure, the method may include connecting the first external electronic device with a second external electronic device 802 in response to receiving a user input for transmitting the image, the identification information, the location information, and the contextual information to the second external electronic device when there is a first external electronic device 803 connected to the electronic device through the communication circuit of the electronic device at the point in time when the image is acquired.

According to an embodiment of the disclosure, the method may include obtaining the identification information and the contextual information about the first application when a first application is executing at the point in time when the image is acquired, and an execution screen of the first application is not displayed on the display. The method may include storing the image and the identification information and the contextual information about the first application together.

According to an embodiment of the disclosure, a non-transitory computer-readable storage medium may store a program for performing an operating method of the electronic device 101, 301, 601, 701, 801, 901, 1001, or 1301. The operating method of the electronic device may include receiving a first user input for capturing a screen being displayed on the display 110 or display module 1360 of the electronic device. The method may include acquiring an image, which is obtained by capturing the screen, in response to the first user input. The method may include acquiring identification information of at least one application running on the electronic device at a point in time when the image is acquired, location information indicating a location where an execution screen of the at least one application is displayed, and contextual information about an execution context of the at least one application. The method may include storing the image, the identification information, the location information, and the contextual information together.

According to an embodiment of the disclosure, an electronic device 102, 702, 802, 902, 903, 1002, or 1301 may include a display 150 or display module 1360, a communication circuit 160 or communication module 1390, memory 170 or 1330, and a processor 180 or 1320. The memory may store instructions. When executed by the processor, the instructions may cause the electronic device to receive a request for reproducing an execution state of at least one application at a time point of screen capture of an external electronic device 101, 301, 601, 701, 801, 901, 1001, 1302, 1304, or 1308 through the communication circuit. When executed by the processor, the instructions may cause the electronic device to receive an image obtained by capturing a screen of the external electronic device, identification information of the at least one application, location information indicating a location where an execution screen of the at least one application is displayed, and contextual information about an execution context of the at least one application through the communication circuit in response to receiving a user input for accepting the request. When executed by the processor, the instructions may cause the electronic device to execute the at least one application corresponding to the identification information. When executed by the processor, the instructions may cause the electronic device to display the execution screen of the at least one application on the display based on the location information. The execution screen of each application may correspond to contextual information of each application.

According to an embodiment of the disclosure, when executed by the processor, the instructions may cause the electronic device to display an execution screen of one of the plurality of applications on the display when the captured screen of the external electronic device includes execution screens of a plurality of applications, and the electronic device is incapable of displaying the execution screens of the plurality of applications on one screen. When executed by the processor, the instructions may cause the electronic device to provide a list of a plurality of applications including the displayed execution screen and the other execution screens not displayed, in response to a user input for identifying a list of recently executed applications.

According to an embodiment of the disclosure, when executed by the processor, the instructions may cause the electronic device to display the execution screens of the plurality of applications on the display based on the location information when the captured screen of the external electronic device includes execution screens of a plurality of applications, and the electronic device is capable of displaying the execution screens of the plurality of applications on one screen. The location information may include the layout of the execution screens of the plurality of applications.

According to an embodiment of the disclosure, an operating method of an electronic device 102, 702, 802, 902, 903, 1002, or 1301 may include receiving a request for reproducing an execution state of at least one application at a time point of screen capture of an external electronic device 101, 301, 601, 701, 801, 901, 1001, 1302, 1304, or 1308 through a communication circuit 160 or communication module 1390 of the electronic device. The method may include receiving an image obtained by capturing a screen of the external electronic device, identification information of the at least one application, location information indicating a location where an execution screen of the at least one application is displayed, and contextual information about an execution context of the at least one application through the communication circuit in response to receiving a user input for accepting the request. The method may include executing the at least one application corresponding to the identification information. The method may include displaying the execution screen of the at least one application on a display 150 or display module 1360 of the electronic device based on the location information. The execution screen of each application may correspond to contextual information of each application.

According to an embodiment of the disclosure, the displaying of the execution screen of the at least one application may include displaying an execution screen of one of the plurality of applications on the display when the captured screen of the external electronic device includes execution screens of a plurality of applications, and the electronic device is incapable of displaying the execution screens of the plurality of applications on one screen. The displaying of the execution screen of the at least one application may include providing a list of a plurality of applications including the displayed execution screen and the other execution screens not displayed, in response to a user input for identifying a list of recently executed applications.

According to an embodiment of the disclosure, the displaying of the execution screen of the at least one application may include displaying the execution screens of the plurality of applications on the display based on the location information when the captured screen of the external electronic device includes execution screens of a plurality of applications, and the electronic device is capable of displaying the execution screens of the plurality of applications on one screen. The location information may include the layout of the execution screens of the plurality of applications.

According to an embodiment of the disclosure, a non-transitory computer-readable storage medium may store a program for performing an operating method of an electronic device 102, 702, 802, 902, 903, 1002, or 1301. The operating method of the electronic device may include receiving a request for reproducing an execution state of at least one application at a time point of screen capture of an external electronic device 101, 301, 601, 701, 801, 901, 1001, 1302, 1304, or 1308 through a communication circuit 160 or communication module 1390 of the electronic device. The method may include receiving an image obtained by capturing a screen of the external electronic device, identification information of the at least one application, location information indicating a location where an execution screen of the at least one application is displayed, and contextual information about an execution context of the at least one application through the communication circuit in response to receiving a user input for accepting the request. The method may include executing the at least one application corresponding to the identification information. The method may include displaying the execution screen of the at least one application on a display 150 or display module 1360 of the electronic device based on the location information. The execution screen of each application may correspond to contextual information of each application.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “Ist” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1340) including one or more instructions that are stored in a storage medium (e.g., internal memory 1336 or external memory 1338) that is readable by a machine (e.g., the electronic device 1301). For example, a processor (e.g., the processor 1320) of the machine (e.g., the electronic device 1301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory storing one or more computer programs; and
one or more processors communicatively coupled to the display and the memory,
wherein the one or more computer programs include computer-executable instructions that, when executed by the one or more processors individually or collectively, cause the electronic device to:
receive a first user input for capturing a screen being displayed on the display,
in response to the receiving of the first user input, acquire an image obtained by capturing the screen,
based on the acquiring of the image, acquire identification information of at least one application running on the electronic device at a point in time when the image is acquired, location information indicating a location where an execution screen of the at least one application is displayed, and contextual information about an execution context of the at least one application, and
store the image, the identification information, the location information, and the contextual information together.

2. The electronic device of claim 1, wherein the one or more computer programs further include computer-executable instructions that, when executed by the one or more processors individually or collectively, cause the electronic device to:
store the identification information, the location information, and the contextual information as metadata of the image.

3. The electronic device of claim 1, further comprising:
a communication circuit,
wherein the one or more computer programs further include computer-executable instructions that, when executed by the one or more processors individually or collectively, cause the electronic device to:
transmit, through the communication circuit to a cloud server, the image, the identification information, the location information, and the contextual information, and
wherein the image, the identification information, the location information, and the contextual information are listed and stored in the cloud server at each capture time point.

4. The electronic device of claim 1, further comprising:
a communication circuit,
wherein the one or more computer programs further include computer-executable instructions that, when executed by the one or more processors individually or collectively, cause the electronic device to:
establish, through the communication circuit, a communication connection with an external electronic device in proximity to the electronic device, and
transmit, to the external electronic device, the image, the identification information, the location information, and the contextual information.

5. The electronic device of claim 1, further comprising:
a communication circuit,
wherein the one or more computer programs further include computer-executable instructions that, when executed by the one or more processors individually or collectively, cause the electronic device to:
after the acquiring of the image, receive a second user input for sharing the image, the identification information, the location information, and the contextual information,
in response to the receiving of the second user input, display a list of data to be transmitted on the display,
receive a third user input for selecting first pieces of data, which does not need to be transmitted, from among the data included in the list, and
in response to the receiving of the third user input, transmit second pieces of data, other than the first pieces of data selected via the third user input, through the communication circuit to at least one of an external electronic device or a cloud server in proximity to the electronic device.

6. The electronic device of claim 1, further comprising:
a communication circuit,
wherein the one or more computer programs further include computer-executable instructions that, when executed by the one or more processors individually or collectively, cause the electronic device to:
when there is a first external electronic device connected to the electronic device through the communication circuit at the point in time when the image is acquired, connect the first external electronic device with a second external electronic device in response to receiving a user input for transmitting the image, the identification information, the location information, and the contextual information to the second external electronic device.

7. The electronic device of claim 1, wherein the one or more computer programs further include computer-executable instructions that, when executed by the one or more processors individually or collectively, cause the electronic device to:
when a first application is executing at the point in time when the image is acquired, and an execution screen of the first application is not displayed on the display, obtain the identification information and the contextual information about the first application, and
store the image, the identification information, and the contextual information about the first application together.

8. An electronic device comprising:
a display;
a communication circuit;
memory storing one or more computer programs; and
one or more processors communicatively coupled to the display, the communication circuit, and the memory,
wherein the one or more computer programs include computer-executable instructions that, when executed by the one or more processors individually or collectively, cause the electronic device to:
receive, through the communication circuit, a request for reproducing an execution state of at least one application at a time point of screen capture of an external electronic device;
in response to receiving a user input for accepting the request, receive, through the communication circuit, an image obtained by capturing a screen of the external electronic device, identification information of the at least one application, location information indicating a location where an execution screen of the at least one application is displayed, and contextual information about an execution context of the at least one application;
execute the at least one application corresponding to the identification information; and
display the execution screen of the at least one application on the display based on the location information, and
wherein an execution screen of each application corresponds to contextual information of each application.

9. The electronic device of claim 8, wherein the one or more computer programs further include computer-executable instructions that, when executed by the one or more processors individually or collectively, cause the electronic device to:
when the screen of the external electronic device that is captured includes execution screens of a plurality of applications, and the electronic device is incapable of displaying the execution screens of the plurality of applications on one screen, display, on the display, one execution screen of one of the plurality of applications, and
in response to receiving a user input for identifying a list of recently executed applications, provide a list of the plurality of applications including the one execution screen and other execution screens not displayed.

10. The electronic device of claim 8,
wherein the one or more computer programs further include computer-executable instructions that, when executed by the one or more processors individually or collectively, cause the electronic device to:
when the screen of the external electronic device that is captured includes execution screens of a plurality of applications, and the electronic device is capable of displaying the execution screens of the plurality of applications on one screen, display the execution screens of the plurality of applications on the display based on the location information, and
wherein the location information includes a layout of the execution screens of the plurality of applications.

11. A method performed by an electronic device, the method comprising:
receiving, by the electronic device, a first user input for capturing a screen being displayed on a display of the electronic device;
in response to the receiving of the first user input, acquiring, by the electronic device, an image obtained by capturing the screen;
based on the acquiring of the image, acquiring, by the electronic device, identification information of at least one application running on the electronic device at a point in time at which the image is acquired, location information indicating a location where an execution screen of the at least one application is displayed, and contextual information about an execution context of the at least one application; and
storing, by the electronic device, the image, the identification information, the location information, and the contextual information together.

12. The method of claim 11, wherein the storing of the identification information, the location information, and the contextual information comprises:
storing, by the electronic device, the identification information, the location information, and the contextual information as metadata of the image.

13. The method of claim 11, further comprising:
transmitting, by the electronic device through a communication circuit of the electronic device to a cloud server, the image, the identification information, the location information, and the contextual information,
wherein the image, the identification information, the location information, and the contextual information are listed and stored in the cloud server at each capture time point.

14. The method of claim 11, further comprising:
establishing, by the electronic device through a communication circuit of the electronic device, a communication connection with an external electronic device in proximity to the electronic device; and
transmitting, by the electronic device through the communication circuit to the external electronic device, the image, the identification information, the location information, and the contextual information.

15. The method of claim 11, further comprising:
after the acquiring of the image, receiving, by the electronic device, a second user input for sharing the image, the identification information, the location information, and the contextual information;
in response to the receiving of the second user input, displaying, by the electronic device, a list of data to be transmitted on the display;
receiving a third user input for selecting first pieces of data, which does not need to be transmitted, from among the data included in the list; and
in response to the receiving of the third user input, transmitting, by the electronic device through a communication circuit of the electronic device to an external electronic device, second pieces of data, other than the first pieces of data selected via the third user input.

16. The method of claim 11, further comprising:
based on a first external electronic device being connected to the electronic device through a communication circuit of the electronic device at the point in time at which the image is acquired, connecting, by the electronic device, the first external electronic device with a second external electronic device in response to receiving a user input for transmitting the image, the identification information, the location information, and the contextual information to the second external electronic device.

17. The method of claim 11, further comprising:
based on a first application being executing at the point in time at which the image is acquired, and an execution screen of the first application is not displayed on the display, obtaining, by the electronic device, the identification information and the contextual information about the first application; and
storing, by the electronic device, the image, the identification information, and the contextual information about the first application together.

18. A method performed by an electronic device, the method comprising:
receiving, by the electronic device through a communication circuit of the electronic device, a request for reproducing an execution state of at least one application at a time point of screen capture of an external electronic device;
in response to receiving a user input for accepting the request, receiving, by the electronic device through the communication circuit, an image obtained by capturing a screen of the external electronic device, identification information of the at least one application, location information indicating a location where an execution screen of the at least one application is displayed, and contextual information about an execution context of the at least one application;
executing, by the electronic device, the at least one application corresponding to the identification information; and
displaying, by the electronic device on a display of the electronic device, the execution screen of the at least one application based on the location information,
wherein an execution screen of each application corresponds to contextual information of each application.

19. The method of claim 18, wherein the displaying of the execution screen of the at least one application comprises:
based on the screen of the external electronic device that is captured including execution screens of a plurality of applications, and the electronic device being incapable of displaying the execution screens of the plurality of applications on one screen, displaying, by the electronic device on the display, one execution screen of one of the plurality of applications; and
in response to receiving a user input for identifying a list of recently executed applications, providing, by the electronic device, a list of the plurality of applications including the one execution screen and other execution screens not displayed.

20. The method of claim 18,
wherein the displaying of the execution screen of the at least one application comprises:
based on the screen of the external electronic device that is captured including execution screens of a plurality of applications, and the electronic device being capable of displaying the execution screens of the plurality of applications on one screen, displaying, by the electronic device on the display, the execution screens of the plurality of applications based on the location information, and
wherein the location information includes a layout of the execution screens of the plurality of applications.
